(19) United States
(12) Patent Application Publication
(10) Pub. No.: US 2017/0140174 A1
(43) Pub. Date: May 18, 2017

(54) Systems and Methods for Obtaining Authorization to Release Personal Information Associated with a User

(71) Applicant: Trunomi LTD, Pembroke (BM)

(72) Inventors: Stuart H. Lacey, Paget (BM); Naresh Singhal, Mountain View, CA (US); Graham R. Burton, Paget (BM); Kartik Venkatesh, Bothell, WA (US); Bradley E. Leatherwood, San Jose, CA (US)

(21) Appl. No.: 15/421,198

(22) Filed: Jan. 31, 2017

Related U.S. Application Data
(63) Continuation-in-part of application No. 15/017,533, filed on Feb. 5, 2016.
Application No. 15/017,533 is a continuation-in-part of application No. 14/874,337, filed on Oct. 2, 2015.
(60) Provisional application No. 62/112,801, filed on Feb. 6, 2015.
(60) Provisional application No. 62/059,087, filed on Oct. 2, 2014.

(51) Int. Cl. G06F 21/62; H04L 29/06

(52) U.S. Cl. CPC G06F 21/6245; H04L 63/0823; H04L 63/0272; H04L 63/0861; G06K 9/00892

(57) ABSTRACT

An exemplary method of obtaining authorization to release personal information associated with a user includes, at a server system, receiving a request for personal information associated with a user from a third party. The method further includes generating, in a system agnostic widget, a consent request for requesting authorization to release the personal information associated with the user to the third party and transmitting the consent request to a client device of the user via the widget. In response to receiving authorization to release the personal information from the client device via the widget: (1) facilitating provision of the personal information to the third party, and (2) storing the authorization in association with an account of the user.

### CROSS-REFERENCE

This application is a continuation-in-part of U.S. patent application Ser. No. 15/017,533, “Systems and methods for generating an auditable digital certificate,” filed on Feb. 5, 2016, which claims the benefit of U.S. Provisional Application No. 62/112,801, and this application is a continuation-in-part of U.S. patent application Ser. No. 14/874,337, “Systems and methods for context-based permissioning of personally identifiable information,” filed on Oct. 2, 2015, which claims the benefit of U.S. Provisional Application No. 62/059,087.

### TECHNICAL FIELD

The disclosed implementations relate generally to computer networks, and more specifically, to systems and methods for obtaining authorization to release personal information associated with a user.

### BACKGROUND

Personally identifiable information, or “PII,” (also referred to herein as personal information) is information that can be used, either alone or in combination with other information, to uniquely identify a particular person. In the modern computing age, users generate significant amounts of PII in their day-to-day lives, often without awareness that they are doing so, or without appreciating the extent to which the information allows them to be uniquely identified. As devices are able to collect increasingly more data about users (and more sensitive data, such as health information, location information, etc.), privacy concerns about PII are becoming more germane.

Currently, each collector of PII is responsible for informing users what data is being collected and how it is being used and for what purpose. However, with so many different entities collecting, storing, and using a person's PII, it is difficult for people to understand exactly which entities they have permitted to collect their PII, and what those entities are permitted to do with their PII. Moreover, it is difficult for collectors of PII to effectively provide permissions, record and organize the granted (or denied) permissions, and also provide an adequate experience to its customers. To further complicate the situation, regulators and governments are becoming increasingly aware of privacy concerns associated with collecting of personal information and are looking to enact legislation which mandates how and which controls be put in place.

Enterprises may individually program consent requests into their respective platforms (e.g., webpages, software applications, and the like). However, such an approach has numerous shortcomings as individual programs can be presented to users in an undesirable fashion. In addition, in view of new legislation, the individual programs lack robust certification and evidentiary features. In the absence of the features, enterprises are incapable of gathering sufficient evidence to show that users actually provided consent. Based on these shortcomings, enterprises may lose customers, may lack sufficient evidence to withstand a third party audit, and may waste valuable resources.

### SUMMARY

Accordingly, it would be advantageous to provide systems and methods for a centralized consent service that manages collection and storage of personal information which is seamlessly integrated across various platforms (e.g., via a system agnostic widget). Moreover, it would be advantageous for the centralized consent service to allow enterprises to comply with legislation while also providing a satisfactory experience to users. Furthermore, it would be advantageous for the centralized consent service to provide systems, methods, and user interfaces whereby users can control multiple types of PII and multiple consumers of PII in a single, well organized, easy to understand and easy to use environment. In this way, the centralized consent service may provide a secure consent service (e.g., withstand a third party audit) that delivers a satisfactory experience to users.

In accordance with some implementations, a method for obtaining authorization to release personal information associated with a user is disclosed. The method is performed at a server system with one or more processors and memory storing one or more programs for execution by the one or more processors. The method includes receiving, from a third party, a request for personal information associated with a user; generating, in a system agnostic widget, a consent request for requesting authorization to release the personal information associated with the user to the third party; transmitting the consent request to a client device of the user via the widget; and in response to receiving authorization to release the personal information from the client device via the widget, facilitating provision of the personal information to the third party, and storing the authorization in association with an account of the user.

In accordance with some implementations, a server system includes one or more processors/cores, memory, and one or more programs; the one or more programs are stored in the memory and configured to be executed by the one or more processors/cores and the one or more programs include instructions for performing the operations of the method described above. In accordance with some implementations, a non-transitory computer-readable storage medium has stored therein instructions that when executed by one or more processors/cores of a server system, cause the server system to perform the operations of the method described.

In some implementations, the consent request comprises information regarding the consent. In some implementations, the information regarding the consent comprises a first unique identifier for the third party, a second unique identifier for the user, and/or a context associated with the request. Furthermore, in some implementations, the information regarding the consent further comprises text for statutory compliance.

In some implementations, the method further includes receiving a digital representation of the information regarding the consent included in the consent request via a capture feature of the widget and storing the digital representation in association with the account of the user.

In some implementations, the method further includes receiving an additional digital representation of the authorization received in the system agnostic widget via the capture feature of the widget and storing the additional digital representation in association with the account of the user.

In some implementations, the method further includes determining whether any prior consent(s) received from the user apply to the request and generating the consent request is performed upon determining that none of the prior consents apply to the request.

In some implementations, the personal information associated with the user is stored in a database controlled by the third party or another third party. Alternatively or in addition, the method further comprises, in some implementations, receiving, from the client device, the personal information of the user before receiving the request from the third party and storing the personal information in association with the account of the user.

In some implementations, facilitating provision of the personal information to the third party comprising forwarding the stored personal information to the third party.

In some implementations, the method further includes, subsequent to receiving the authorization to release in the system agnostic widget from the user, updating a log in the widget to include the consent authorizing release of the personal information to the third party.

In some implementations, the method further includes, receiving a view request, from the client device of the user, to view the log comprising one or more consents authorizing release of the personal information, transmitting the log to the client device via the widget, and after transmitting the log to the client device via the widget, receiving one or more revoke requests from the user revoking at least one consent of the one or more consents authorizing release of the personal information.

### BRIEF DESCRIPTION OF THE DRAWINGS

The implementations disclosed herein are illustrated by way of example, and not by way of limitation, in the figures of the accompanying drawings. Like reference numerals refer to corresponding parts throughout the drawings.

FIGS. 1A-1B are block diagrams illustrating a client-server environment, in accordance with some implementations.

FIG. 2 is a block diagram illustrating a client computer device, in accordance with some implementations.

FIG. 3 is a block diagram illustrating a requesting computer device, in accordance with some implementations.

FIG. 4 is a block diagram illustrating a server computer device, in accordance with some implementations.

FIGS. 5A-5D are flow diagrams illustrating a method of verifying a user's identity, in accordance with some implementations.

FIG. 6 is a flow diagram illustrating a method of verifying a document, in accordance with some implementations.

FIG. 7 shows a schematic representation of a certificate data structure, according to some implementations of the invention.

FIGS. 8A-8C are flow charts of a fraud alert process flow, according to some implementations of the invention.

FIGS. 9A-9D are flow diagrams illustrating a method for providing access to personal information (PII) of a user, in accordance with some implementations.

FIGS. 10A-10B are exemplary graphic user interfaces (GUIs) provided to a client computing device via a system agnostic widget, in accordance with some implementations.

### DETAILED DESCRIPTION

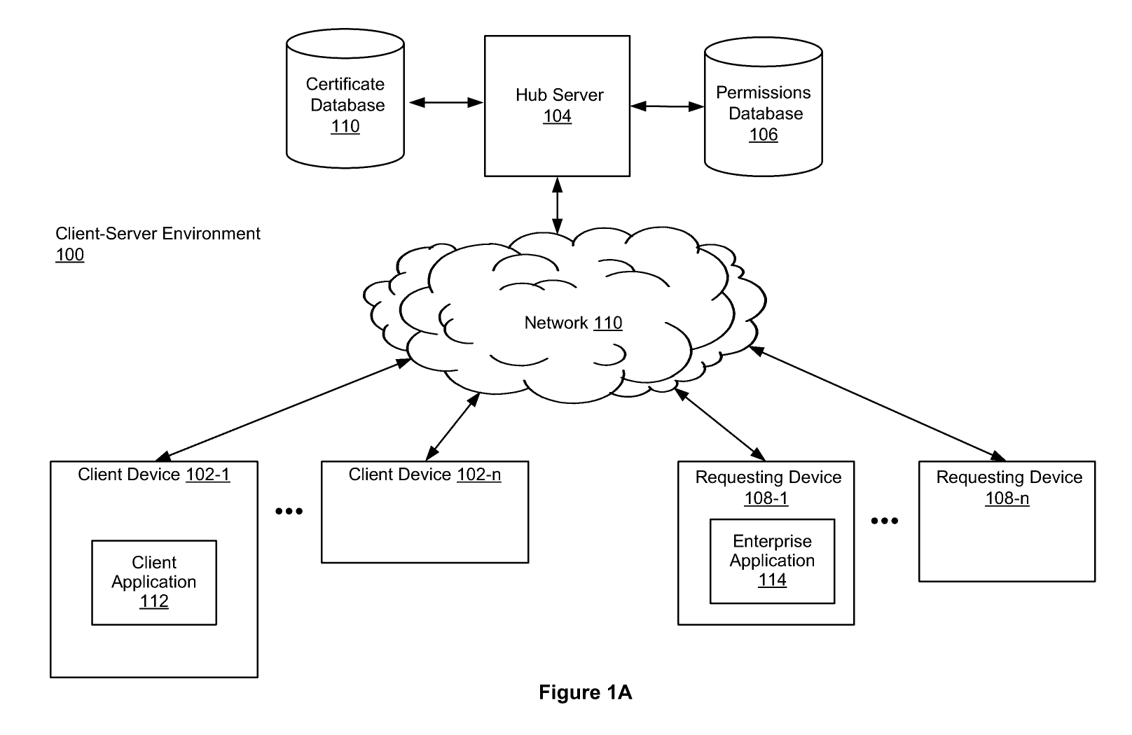

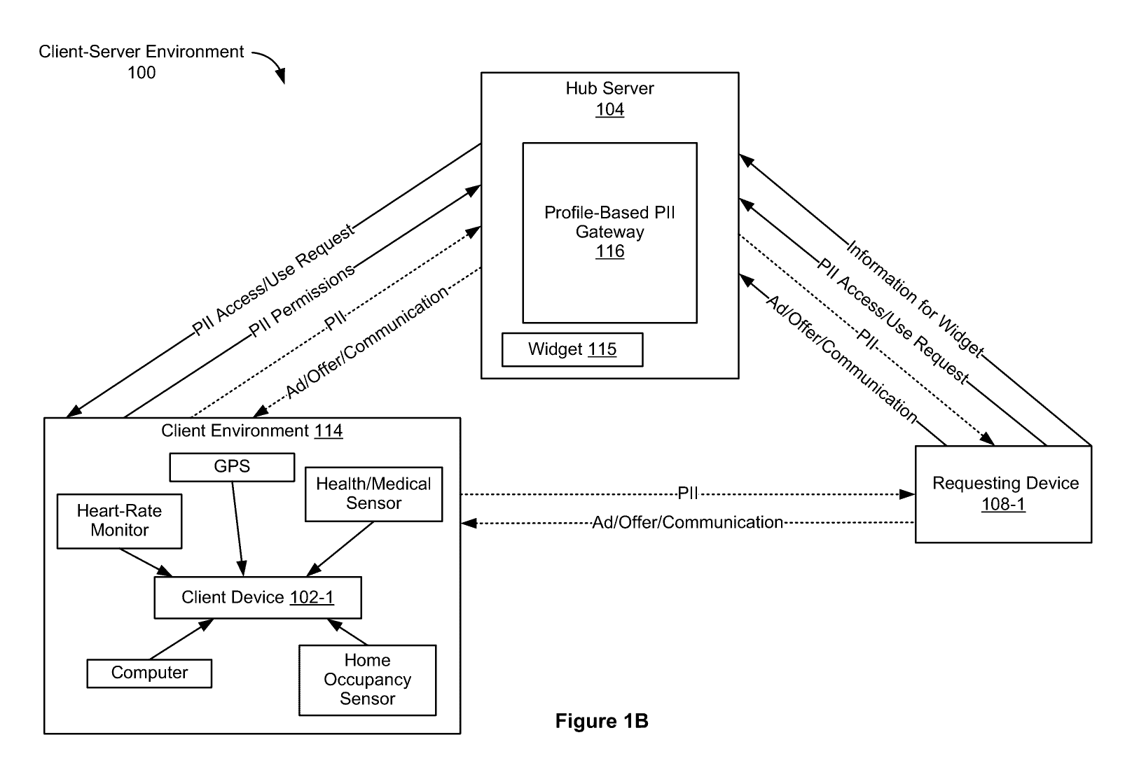

Attention is now directed to the figures, and in particular to FIG. 1A, which is a block diagram of a client-server environment 100, according to some implementations, in which sharing of personal information is facilitated by a central hub server, among other things. The client-server environment 100 includes client devices 102-1 . . . 102-n, a hub server 104, and requesting devices 108-1 . . . 108-n (also referred to herein as enterprise device(s)), all connected through a network 110. The network 110 includes any of a variety of networks, including wide area networks (WAN), local area networks (LAN), Personal Area Networks, metropolitan area networks, VPNs, local peer-to-peer, ad-hoc connections, wireless networks, wired networks, the Internet, or a combination of such networks.

In some implementations, the client device 102-1 is associated with an individual. In some implementations, the client device 102-1 is used to capture and/or process documents and other information associated with an individual. In some implementations, the client device 102-1 includes a client application 112 that facilitates the capture and/or processing of documents and other personal information and communicates with one or both of the server 104 and the requesting device 108-1. In some implementations, the client application 112 also generates verification ratings for documents, extracts information from the documents, and encrypts the documents (as well as the verification ratings and extracted information) prior to sending the documents to the server 104. The client device 102-1 and the client application 112, and the functions and methods that they perform, are discussed herein. Any description(s) of the client device 102-1, or of the functions or methods performed by the client device 102-1, apply equally to any or all instances of the client devices 102-n. (Moreover, in some implementations, functions or methods described as being associated with or performed by the client device 102-1 are performed by the enterprise device 108-1, such as when a bank or other financial institution creates preliminary accounts for its customers.) Exemplary client devices include a desktop computer, a laptop computer, a tablet computer, a mobile electronic device, a mobile phone (e.g., a “smartphone”), a digital media player, or any other appropriate electronic device (or a kiosk housing any of the aforementioned devices).

Alternatively or in addition, in some implementations, the client application 112 facilitates transmission of PII to other devices, such as the hub server 104 and/or requesting devices 108-n (e.g., a third party). In some implementations, the PII transmitted from the client device 102-1 to other devices includes information resulting from direct interactions with the client device 102-1 (e.g., internet browsing history, user profiles, location information, application usage information, device operational information/logs, etc.). In some implementations, the transmitted PII includes information received by the client device 102-1 from other devices and/or peripherals, such as wearables, heart-rate monitors, occupancy sensors, health/medical/biometric sensors, connected home devices, drones, autonomous vehicles, and the like.

In some implementations, the client device 102-1 also facilitates requesting and receiving user consent for sharing of PII, including sharing of PII from the client device 102-1 to other devices and/or entities, and/or sharing of PII between other third-parties. For example, a user may be prompted, via the client device 102-1, to approve or deny a request for one third-party to share that user's PII with another third-party. In some implementations, the client device prompts the user by displaying, on its display, a graphical user interface associated with a system agnostic widget. In some implementations, the client application 112 present consent notices (e.g., consent requests) to the user of the client device 102-1. In some implementations, the client application 112 executes code associated with a system agnostic widget when presenting the consent notices. The system agnostic widget is discussed in further detail below with reference to FIG. 1B and method 900.

In some implementations, the client device 102-1 also maintains or facilitates maintenance of an “active” context profile of a user. An active context profile may relate to one or more aspects of the user's current environment, current activity, and/or current interests. Context profiles include, for example, contexts such as “travel,” “home,” “shopping,” “driving,” “do not disturb,” “fitness,” “health emergency,” “work,” “social,” and the like. In some implementations, the client device 102-1 automatically determines an active context profile. This determination can be based on any one or more of the following factors and/or criteria: time of day, device or application usage, browsing history, location (e.g., from GPS or otherwise), ambient light, ambient temperature, biometric information (e.g., from a biometric sensor), connected devices/accessories (e.g., wearables, or a car's technology system), and the like. In some implementations, other devices in addition to or instead of the client device 102-1 maintain or facilitate maintenance of an active context profile. For example, the hub server 104 may communicate with the client device 102-1 to maintain the user's active context profile. As another example, peripheral devices may provide signals to the client device 102-1 and/or the hub server 104. These signals are indicative of a user's context, or can be used, alone or in combination with other signals, data, calendar entries, etc., to infer the user's context.

In some implementations, the requesting device 108-1 is associated with an entity that receives, stores, uses, or otherwise accesses PII of an individual. For example, a requesting device 108-1 may be associated with an entity or entities that use PII for a variety of reasons (e.g., aggregating and/or storing PII). In some implementations, the enterprise device 108-1 is associated with an entity that requires identity verification from individuals or other entities. In some implementations, the enterprise device 108-1 includes an enterprise application 114 that facilitates the requesting and receipt of identity verification information and other personal information from individuals or entities (e.g., via the server 104). In some implementations, the enterprise device 108-1 communicates with one or both of the server 104 and the client device 102-1. The enterprise device 108-1 and the enterprise application 114, and the functions and methods that they perform, are discussed herein. Any description(s) of the enterprise device 108-1, or of the functions or methods performed by the enterprise device 108-1, apply equally to any or all instances of the enterprise devices 108-n. Exemplary enterprise devices include a desktop computer, a laptop computer, a tablet computer, a mobile electronic device, a server computer (or server computer system), a mobile phone, a digital media player, or any other appropriate electronic device (or a kiosk housing any of the aforementioned devices).

In some implementations, the enterprise application 114 provides information to a system agnostic widget by invoking the widget. For example, when invoking the widget, the enterprise application 114 may provide information regarding scope of the request, legal statements, links to various terms and conditions, a privacy policy, relevant identifications, and the like to the widget. The system agnostic widget is discussed in further detail below with reference to FIG. 1B and method 900.

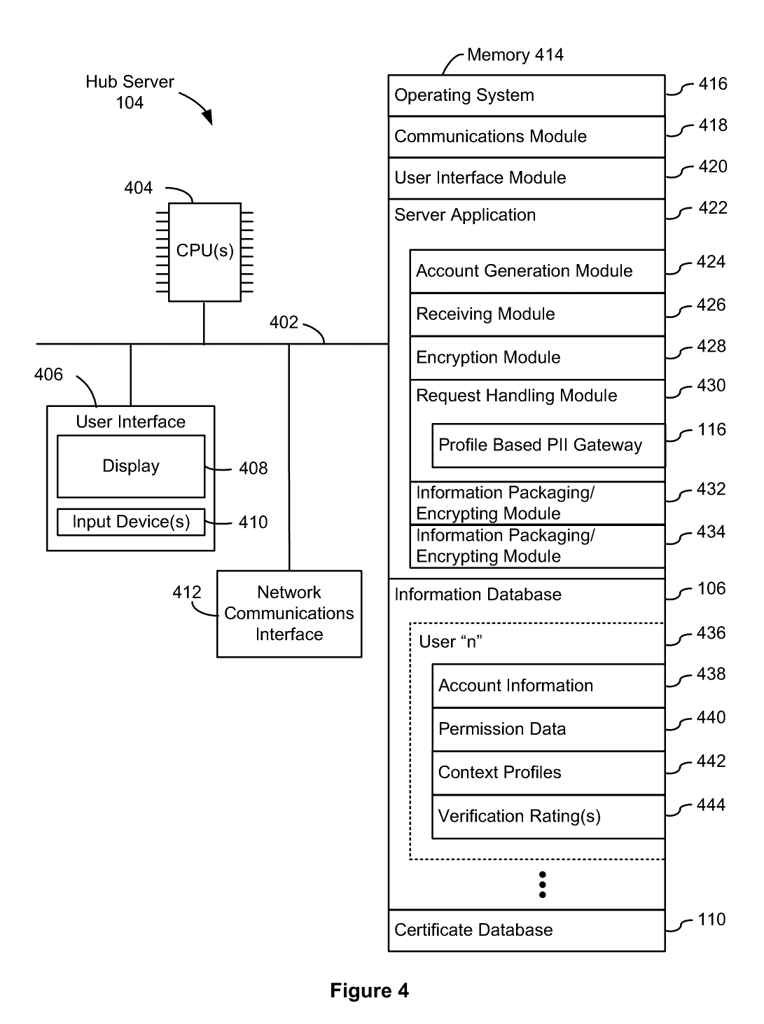

In some implementations, the server 104 (also referred to herein as a hub server) is associated with a service provider that can communicate, via the network 110 and/or other communication means, with multiple client devices (e.g., 102-n) and multiple requesting devices (e.g., 108-n) to provide and/or facilitate provision of document(s) and/or other information between entities (e.g., between one or more third-party entities and/or third-party entities and client devices). In some implementations, the server 104 includes and/or communicates with a user information database 106 (also referred to herein as a permissions database and/or a consent database). The user information database 106 may store information associated with users (e.g., images or other digital representations of personal information, identification documents, utility bills, etc., containers from which documents can be extracted, information extracted from documents, user account information, verification ratings, user scores, etc.). In some implementations, any or all of the foregoing information is encrypted such that only the user with whom the information is associated (and parties authorized by the user) can access and/or view the information. In addition, the user information database 106 may include other information generated by client device 102-1 such as fitness information, location information, and the like. In addition, the user information database 106 may include one or more consents authorizing release of personal information associated with a particular user (e.g., permission data 440, FIG. 4). Moreover, the information database 106 may store digital representations of information included in consent requests (e.g., widget 115 may capture a digital representation of information included in a consent request and may store the digital representation in the information database 106, FIG. 1B).

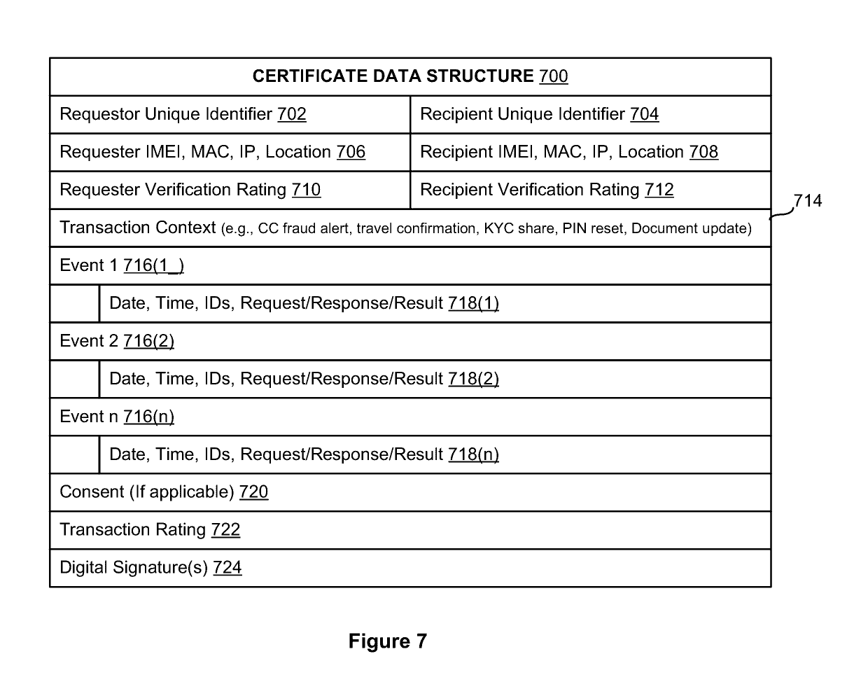

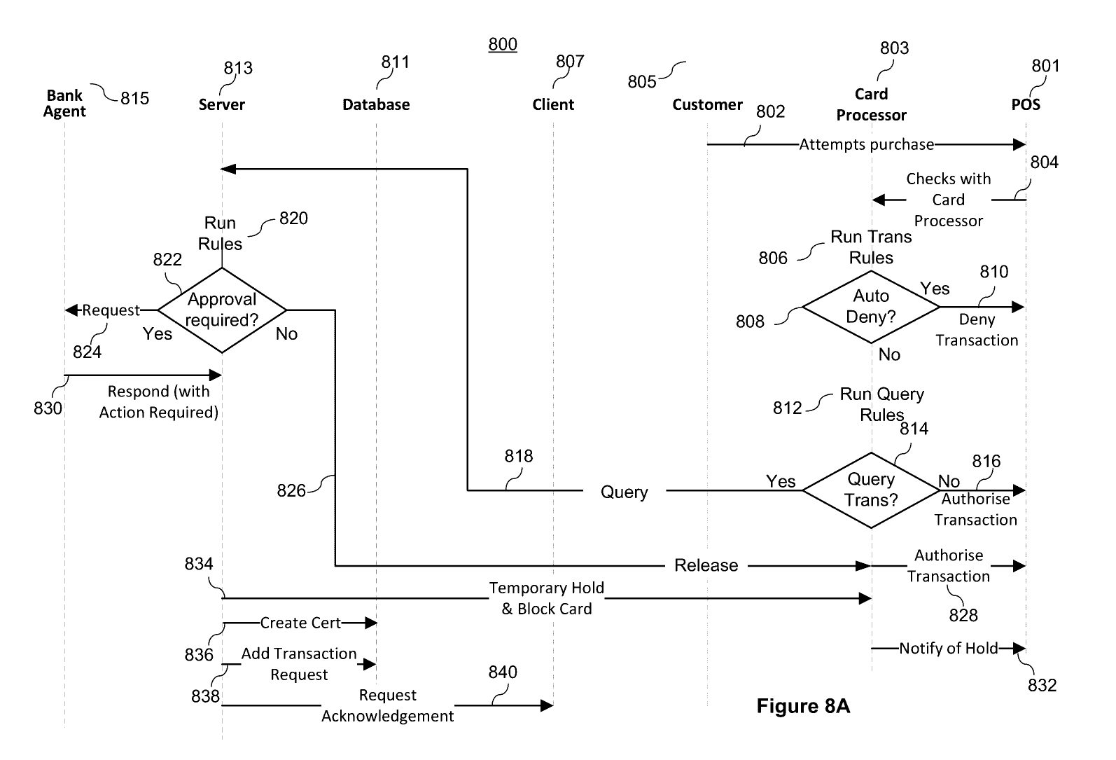

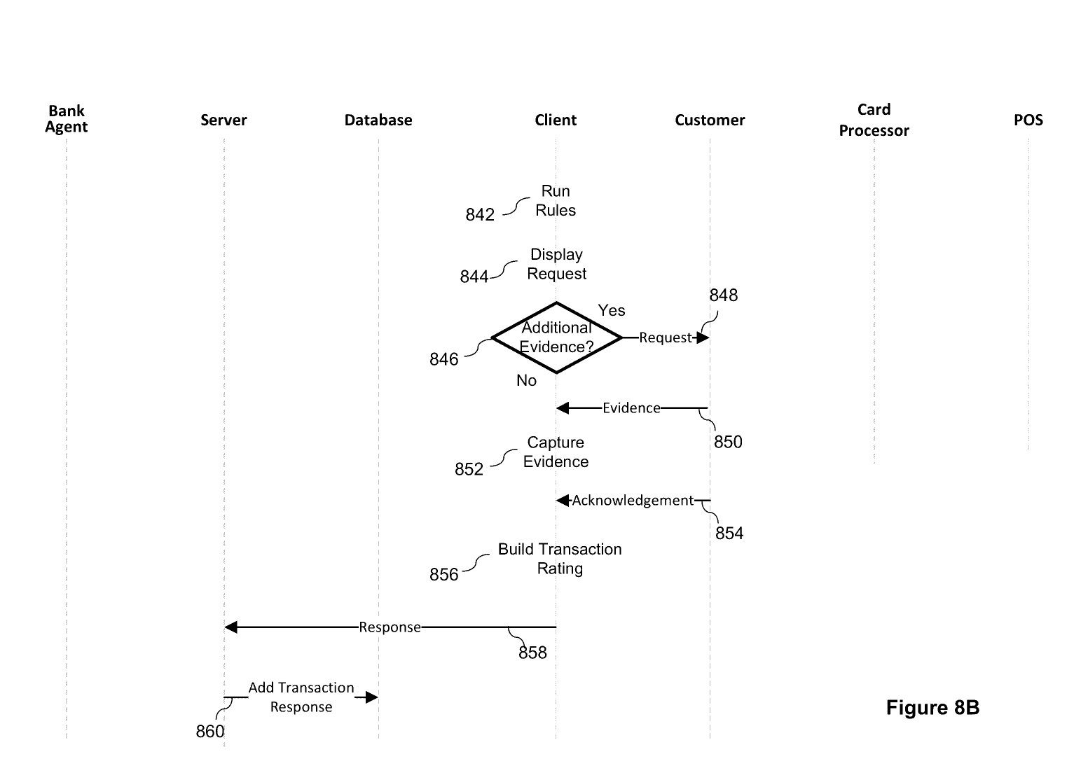

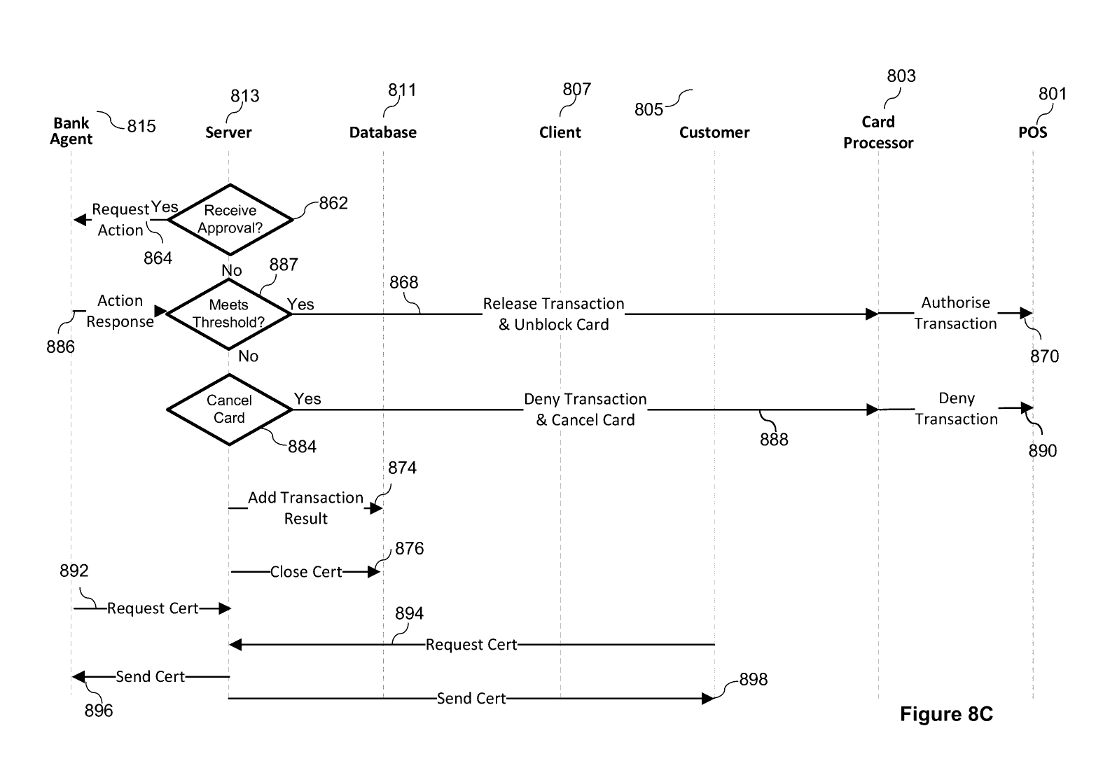

In some implementations, the server 104 includes and/or communicates with a certificate database 110. As described herein, the user certificate database 110 stores transaction certificates that are created for each transaction. An example of the data structure 700 for a transaction certificate is shown in FIG. 7. An example of how a certificate is generated is shown in FIGS. 8A-8C. In some implementations, certificates are used to verify that a transaction occurred, provide details for the transaction, and provide an auditable trail for such transactions.

Referring to FIG. 7, the certificate data structure 700 includes a unique identifier 702 for a requestor of the transaction, e.g., a unique identifier for an individual. The certificate data structure 700 also includes a unique identifier 704 for a recipient of the transaction, e.g., a unique identifier for a bank. These two identifiers 702, 704 are used to identify the counterparties to the transaction. Furthermore, while only two parties are shown and described herein, in some implementations each transaction includes multiple parties (e.g., three or more) and each one has its own unique identifier. For each transaction certificate, additional details for the requestor and receiver may be received and stored. For example, the requestor's IMEI, MAC address, IP address or location 706 may be stored as part of each certificate. Similarly, the recipient's IMEI, MAC address, IP address or location 708 may be stored as part of each certificate.

As described in more detail below, the requester's verification rating 710, and the recipient's verification ratings may also be stored in each transaction certificate. Each transaction certificate also includes the context 714 (e.g., a purpose) for that transaction, e.g., whether the transaction relates to a credit card fraud alert (see FIGS. 8A-C), a travel confirmation, a know-your-customer sharing of information, a personal identification number (PIN) or password reset; updating a document (e.g., updating a passport), or the like. Each transaction certificate also includes one or more transaction events 716(1)-(n). Each transaction event includes the date, time stamp, identifiers, and nature of the event (e.g., a request, response, or result) 718(1)-(n). If the transaction relates to receiving consent or an acknowledgement, then the consent or acknowledgement 720 is stored in the transaction certificate.

In some implementations, a transaction rating 722 is created for each transaction, as explained in more detail with respect to FIGS. 8A-8C, and stored in each certificate. Also in some implementations, when each certificate is closed, the certificate is signed with tamperproof digital signature 724.

Returning to FIG. 1A, using the client-server environment 100 illustrated in FIG. 1A, identity verification documents can be quickly and efficiently shared between an individual and an institution or other entity, allowing the identity of the individual to be quickly and efficiently verified. In particular, and as described herein, the client device 102-1 is used to capture images and/or files of documents that can be used for identity verification, such as government issued photo identification cards and/or credentials (e.g., drivers' licenses, passports, etc.), utility bills, and the like. For example, in some implementations, the client device 102-1 is a smartphone with a digital camera, and an individual uses the camera to capture a photograph of a drivers' license and a utility bill. The smartphone then extracts information from the photographs of the documents, analyzes them, and generates a verification rating for the documents. Then, the photographs, the information extracted from the photographs, and the verification ratings are encrypted and sent to the server 104, which stores these items in the user information database 106 in a secure manner.

A requesting entity then requests identity verification information from an individual (e.g., using the requesting device 108-1), and a request is sent to the individual (e.g., via the server 104). The individual then uses the client device 102-1 and/or the client application 112 to partially or fully approve (or deny) the request. If the request is approved by the individual (e.g., the individual authorizes the requesting entity to access to all or some of the requested information), the requesting entity is granted access to the authorized information via the server 104.

In some implementations, the client-server environment 100 illustrated in FIG. 1A is used for other transactions, like obtaining consent, authorization or acknowledgments from clients, as described with reference to FIGS. 8A-8C. For example, an entity, e.g., a bank, using an requesting device 108(1)-(n) may request a consent or authorization from a client or customer that is using client device 102(1)-(n). The server 104 facilitates obtaining the consent from the customer. In some implementations, certificates are created for each transaction. In some implementations, the server 104 facilitates obtaining the consent from the customer via a system agnostic widget (discussed in further detail below with reference to FIG. 1B and method 900).

The present discussion generally refers to the entity whose identity is being verified as an individual or a “user.” However, identity verification for other entities is contemplated as well, such as for companies, trusts, partnerships, businesses, families, financial institutions, etc. Accordingly, any discussion relating to an individual or a user also applies to other entities or parties whose identity and documents are to be verified and/or shared.

FIG. 1B, is another block diagram of the client-server environment 100, according to some implementations, showing exemplary communications between a client environment 114 and a requesting device 108-1 for provisioning and sharing PII.

FIG. 1B includes a client environment 114. The client environment 114 includes a client device 102-1 in communication with the hub server 104, as well as zero or more additional devices in communication with the hub server 104 and/or the client device 102-1. Dotted lines in FIG. 1B represent communications whose transmission or reception may be contingent upon approval or permission granted by the profile-based PII gateway 116. (Other communications in FIG. 1B may also be contingent on such approval or permission by the profile-based PII gateway 116 or any other component of the client-server environment 100, including other devices/components not shown.)

In some implementations, zero or more of the electronic devices in the client environment 114 also bypass (or are capable of bypassing) the hub server 104 to communicate directly with a requesting device 108-1. Electronic devices that communicate directly to the hub server 104 and/or the requesting device 108-1 are themselves considered to be client devices 102. Electronic devices that only or principally communicate with the hub server 104 and/or the requesting device 108-1 through a separate client device 102-1 are considered to be peripheral devices. As an example, a pedometer that communicates to a client device 102-1 via BLUETOOTH or other short-range communication technology is an example of a peripheral device.

In some implementations, the additional devices include global positioning (GPS) devices (e.g., vehicle or personal navigation devices), drones, RFID tags, iBeacons, heart-rate monitors, personal computers, health/medical/biometric sensors (e.g., blood pressure monitors, galvanic skin response sensors, body temperatures sensors, etc.), occupancy sensors, or the like—effectively any device which can or will be able to collect information which might be used either individually or as part of a set of information that constitutes PII.

FIG. 1B illustrates an exemplary process whereby a requesting device requests to access or use PII of a particular individual by sending a request to a hub server. The requesting device can initiate a request in response to a user input, or automatically (e.g., in response to an automatic detection of a condition). The hub server facilitates the process of requesting and receiving permissions, restrictions, and/or authorizations from the individual, and providing the requested PII (or authorizing use of the PII) by the requesting device. In some implementations, the server 104 facilitates the process using a system agnostic widget.

More specifically, the requesting device 108-1 sends a PII access/use request (“request,” and/or “consent request”) to the hub server 104. In some implementations, the request specifies one or more of: the particular PII being requested (e.g., the user's internet browsing history, the user's heart rate, etc.), what the information may used for, when the information may be used, whether (and with whom) the information may be shared, and the like. In some implementations, the request is accompanied with an identifier of a particular individual, an identifier of the requesting device, a purpose for the request, and/or text for statutory compliance. For example, the entity associated with the hub server 104 (i.e., the company or entity that controls, operates, or is otherwise responsible for the hub server 104 or the services provided thereby) provides individual clients with a unique identifier. Individuals may share this identifier with third parties, who may then request information, from the hub server 104, about the associated individual. By routing PII permissioning requests from multiple third parties through the hub server 104, control over such requests is centralized and standardized, allowing users a single and simple point of contact to control who has access to their PII, as well as what it may be used for, and when it may be used and/or received.

In response to receiving a request from a requesting device 108-1, the hub server 104 processes the request and sends a corresponding request (or forwards the request from the requesting device 108-1) to a device associated with the individual identified in the request (e.g., a user of a client device).

As mentioned above, in some implementations, the server 104 sends the consent request to the client device 102-1 via a system agnostic widget 115. The widget 115 may be a software component of the server 104 that has one or more graphical user interfaces (GUIs) supported by code. The widget 115 is system agnostic because it may be seamlessly integrated across multiple platforms (e.g., across different operating systems, across different web browsers, etc.). In some implementations, the requesting device 108-1 (e.g., enterprise application 114) communicates with the widget 115 and provides the widget 115 with information (e.g., scope of the request, legal statements, etc.) to be included in some of the one or more GUIs (e.g., one or more versions of the consent request) associated with the widget 115. The requesting device 108-1 may communicate the information to the widget 115 by invoking the widget 115. When invoking the widget 115, the requesting device 108-1 may provide one or more versions of the consent request which the widget 115 may seamlessly deploy across various platforms to respective client devices (e.g., present the one or more versions of the consent request in the one or more GUIs associated with the widget 115). In this way, the requesting device 108-1 avoids the costly task of creating individual GUIs each time consent is needed.

To further illustrate, after receiving the information from the enterprise application 114 (or the requesting device 108-1), the widget 115 generates a consent request for the client device 102-1 and sends the consent request to the client device 102-1 (e.g., the widget 115 sends JavaScript, HTML, etc. to the client device 102-1). In some implementations, when generating the consent request, the widget 115 selects, based on one or more conditions associated with the client device 102-1 at the time of the consent request, a respective GUI of the one or more GUIs to send the client device 102-1 (i.e., widget 115 selects version A of the consent request which is presented in the respective GUI). In some implementations, the one or more conditions include a purpose of the request. For example, a first GUI may be selected when the request is seeking new personal information from the user (e.g., version A) and a second GUI may be selected when the request is seeking to reuse personal information already possessed by the requesting device 108-1 (e.g., version B). The circumstances and situations will differ between respective users and the server 104 may log these differences in a centralized location (e.g., in information database 106, FIG. 4).

Thereafter, the client device 102-1 receives and renders the widget 115 to display the respective GUI on the client device 102-1 (e.g., the client device renders code (e.g., JavaScript, HTML, etc.) provided by the widget 115). In some implementations, the user is proactively alerted to the request, such as with a popup message on a screen, an audible alert, a notification icon, or the like. In some implementations, the request is placed into an inbox or queue of requests that the user reviews at any convenient time. An operator of the requesting device 108-1, when invoking the widget 115, may define how the consent request provided via the widget 115 is displayed on the client device 102-1.

In some implementations, instead of sending a request to the user, the request is validated against a set of rules established by the user (either on their device or on the gateway), and is then further validated against their active context. Responses are thus automatically managed based on the pre-established rules and the user's active context.

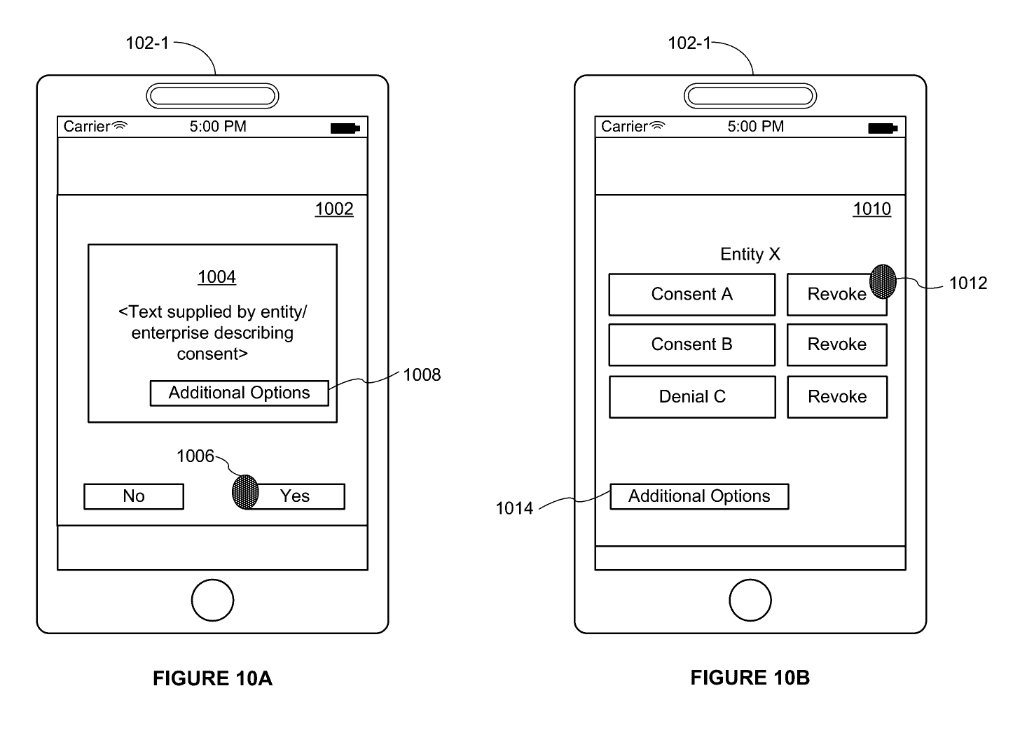

One or more devices associated with the client environment 114 (e.g., the client device 102-1) sends PII permissions back (or lack thereof) to the hub server 104. In some implementations, the user of the client device 102-1 interacts with the respective GUI provided by the hub server 104 (e.g., via the widget 115) to send permissions back to the hub server 104 (e.g., user selection 1006, FIG. 10A). In some implementations, the returned permissions include approval or denial of the request (in whole or in part, as described herein), as well as assignments of particular context profiles for which the permissions are granted. For example, a requesting device 108-1 may send a request to continuously receive the user's heart rate information for the purpose of monitoring and tracking the user's heart rate exertion levels and overall fitness. In response, the user may authorize the requestor to receive and use the date only when the user's “fitness” context profile is active, and restrict the access and/or use of the heart rate information when any other context profile is active. The hub server 104 stores the permissions received from individuals in the permissions database 106. For example, when the request is denied, the hub server stores the denial to create an auditable trail.

In some implementations, if the individual approves the request for PII (and, optionally, one or more other conditions are satisfied), the requested PII is sent to the requesting device 108-1, either directly or through the hub server 104. Alternatively, in some implementations, the requesting device 108-1 (or an entity associated with the requesting device 108-1) controls the PII (e.g., the PII is electrically stored by the entity associated with the requesting device 108-1). In such circumstances, the hub server 104 facilitates provision of the PII by notifying the requesting device 108-1 of the approval of the request.

In some implementations, the hub server 104 includes a profile-based PII gateway 116 that limits access to and/or use of PII data based on the active context profile of the user and the stored permissions granted to the requesting entities. For example, any time a requesting entity wishes to access and/or use PII of a particular user, it must confirm with the hub server 104 whether it is authorized to do so at that time. In response to receiving such a request, the profile-based PII gateway 116 determines the user's active context profile, and then determines whether the user has permitted the requested PII to be shared with the requesting entity when that particular context profile is active. Additionally, in some implementations, a user may elect to initiate the process of sharing PII, in order to facilitate a transaction, for example (or for any purpose). In such instance, the user selects a context and initiates outbound sharing of information (including selected PII) with an entity, subject to any rules and/or restrictions imposed by the hub server 104, the profile-based PII gateway 116, and/or any rules or restrictions associated with the user's context profiles.

As a specific example, if an entity requests heart rate information from a particular user, the profile-based PII gateway 116 determines that the user's active context profile is “fitness,” and further determines that the user has authorized heart-rate information to be shared with the requesting entity when the “fitness” context profile is active. Thus, the profile-based PII gateway 116 will either (i) send the heart rate information to the requestor, (ii) inform the client device 102-1 to send the heart rate information to the requestor, and/or (iii) inform the requestor that they are permitted to request the heart rate information from the client device 102-1.

While FIG. 1B shows PII being sent directly from the client environment 114 to a requesting device 108-1, in some implementations, this communication is still governed by the profile-based PII gateway 116. For example, the PII is sent to the requesting device 108-1 once either or both of the requesting device 108-1 and the client device 102-1 have received confirmation from the profile-based PII gateway 116 that the communication is authorized.

The profile-based PII gateway 116 may also control whether a requesting device 108-1 is permitted to contact an individual with advertisements, offers, or other communications. In some implementations, the requesting device 108-1 sends an advertisement, offer, or other communication to the hub server 104, and the profile-based PII gateway 116 determines whether the individual's permissions allow that particular party to send communications to the individual based on the active context profile. If so, the communication is forwarded to the client device 102-1. If not, it is not forwarded to the client device 102-1 (though it might be stored for retrieval and review at a later stage by the user once an appropriate context profile becomes active). Alternatively, instead of sending the communication to the hub server 104, the requesting device 108-1 may request approval to send information to the client device, and the profile-based PII gateway 116 responds with an approval or a denial, and the requesting device 108-1 reacts accordingly by either sending or not sending the communication as appropriate.

The profile-based PII gateway 116 may allow users to establish permissions related to their PII and the third parties that can access their PII such that they share and receive information in a way that is relevant to their current context. For example, permitting the sharing of clothing size information to times when the user is in a “shopping” profile helps ensure that the user is not accosted with offers, advertisements, or other communications related to clothes shopping when the user is in a different context profile₇ such as “work,” or “vacation.” It also helps provide the user with offers, advertisements, or other communications that are particularly relevant and timely to their active context profile. Thus, when the user is in a “shopping” profile, he or she will be more likely to receive content related to clothing than to nearby athletic events or restaurants near his or her place of work, for example.

Imposing a limited set of permissions, however, can negatively impact the exposure of a user to desirable information. For example, limiting the third parties who may receive PII or contact a user with offers, advertisements, or other communications (or when they are permitted to do so) may prevent the user from learning about a product or service that they might be interested in. Accordingly, in some implementations, users are able to increase the permissions granted to one or more third parties such that additional PII is accessible to the third parties and/or the third parties can communicate to the user in additional ways or in additional contexts. Moreover, the hub server 104 allows users to change permissions of multiple third parties at one time, allowing them the benefit of increased exposure to desirable content without them having to individually change the permissions for each third party. Instead, the user can enter a “discovery mode” where additional permissions are granted to new and/or different third parties. Thereafter, the user can, with only a single request, exit the discovery mode and return each third party to the previously applicable permissions.

Discovery mode affects any of multiple possible permissions. In some implementations, discovery mode allows for the creation of an Interim Privacy Policy (IPP) with additional third parties, giving them the rights and receive and access a user's PII, or allowing additional third parties to contact a user. For example, a user's permissions may only allow a few specific third parties to access PII or send advertisements or offers to the user. When discovery mode is active, however, additional third parties are granted permissions to access the user's PII or send communications to the user. For another example, a user might be shopping for life insurance and under their normal mode would only be sharing their relevant PII (e.g., height, age, weight, health history, heart rate data, fitness data, blood chemistry, etc) with entities already approved by them to receive such information. By entering discovery mode, the user can permission and share this information with a broad set of competitors offering life insurance products, such that each has the same PII information and thus the user can receive a wide set of competitive and accurate personalized quotes. The permissioning of this PII data by the user while in discovery mode creates an IPP and thus enables the other providers to legally have the rights to use the users PII to help them bid for the business. Once the discovery mode is closed, the IPP ends and the related permission ceases.

In some implementations, discovery mode allows third parties to access additional PII information than they otherwise would not be permitted to access. For example, under normal operating modes, a retailer may be permitted to access a user's clothing sizes, whereas in discovery mode, that same retailer (and/or additional retailers) may also be permitted to access a user's browsing history, location, and the like.

In some implementations, discovery mode allows third parties to contact the user via additional communications options. For example, under normal operating modes, a third party may only be permitted to send emails to the user, whereas in discovery mode, that same third party (and/or additional third parties) may also be permitted to contact the user with text messages, pop-up advertisements, banner advertisements, displays on wearables, etc. As another example, under normal operating modes, a third party may only be permitted to send communications to a user's desktop computer, whereas in discovery mode, that same third party (and/or additional third parties) may also be permitted to contact the user on any associated electronic device (e.g., television, smartphone, wearable, vehicle “infotainment” system, etc.

Of course, discovery mode need not grant unlimited permissions to all third parties. Rather, in some implementations, a user can select how discovery mode affects the permissions granted to third parties. For example, one user may configure discovery mode such that permissions are granted to any and all third parties to access the user's PII and/or send communications to the user, and for any subject area. Another user, by contrast, may configure discovery mode such that only a small number of additional third parties are permitted to access the user's PII and/or send communications to the user. Accordingly, in some implementations, the behavior of discovery mode is user-specific and user-configurable.

In some implementations, additional modes, in addition to discovery mode, grant additional and/or different permissions to third parties when they are active. For example, in some implementations, an emergency mode allows any and all PII that may be helpful to rescue a user is sent to emergency responders, health professionals, family members, and/or the like (or access to PII is granted to the foregoing entities). Such PII may include, without limitation, current location, current medications, preexisting health conditions, medical records, and any appropriate biometric information such as heart rate, blood pressure, blood sugar levels, galvanic skin response, body temperature, etc. Thus, like discovery mode, emergency mode changes and/or overrides the permissions that are otherwise active as a result of a particular context profile being active. Thus, for example, if a user's active context profile has very few permissions (corresponding to a “do not disturb” or “family time” mode), emergency mode will expand the permissions so as to allow beneficial services to be provided to the user.

In some implementations, emergency mode is entered automatically upon detection of a certain condition. For example, emergency mode may be entered upon detection that a user has been in a car accident (e.g., based on accelerometer information from a smartphone, collision sensors in a vehicle, etc.), or upon detection that the user is undergoing a health emergency (e.g., based on heart rate, blood sugar, or other biometric information), or the like.

In some implementations, in addition to or instead of automatic selection, emergency mode is entered manually by a user. For example, a user may select emergency mode at any appropriate time, such as after becoming injured.

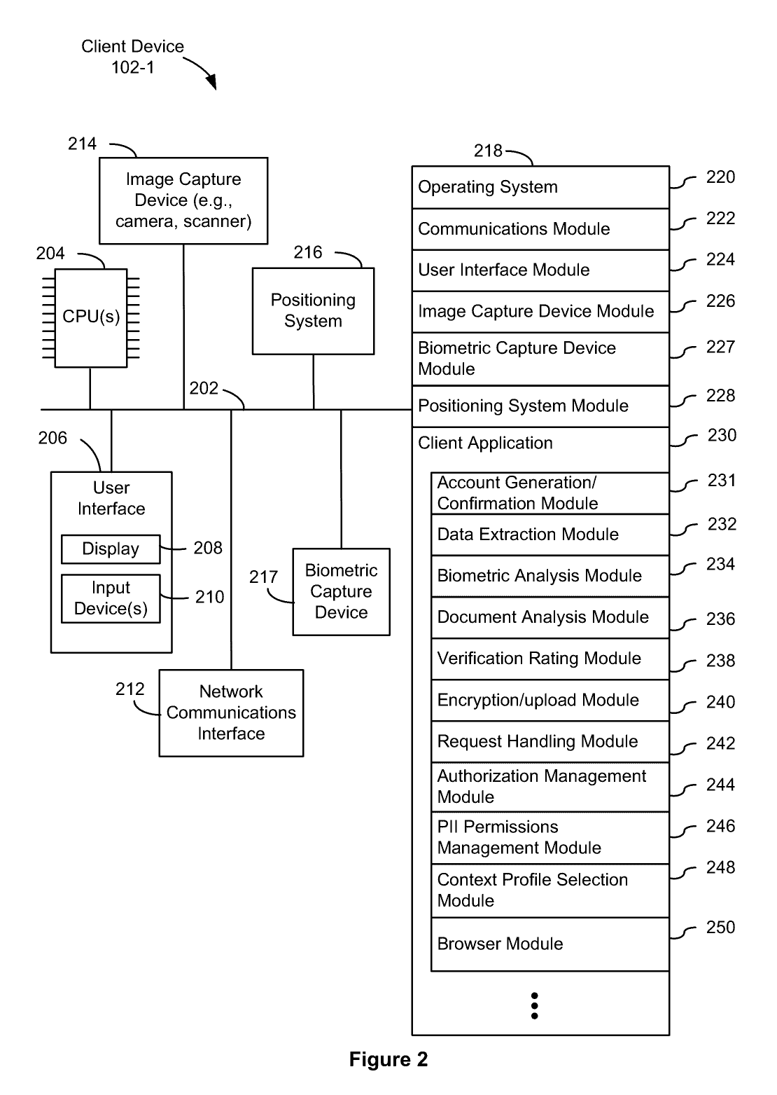

FIG. 2 is a block diagram illustrating a client device 102-1, in accordance with some implementations. While FIG. 2 illustrates one instance of a client device (i.e., client device 102-1), the figure and associated description applies equally to any client device (e.g., 102-1-102-n).

In some implementations, the client device 102-1 is any of: a desktop computer, a laptop computer, a tablet computer, a mobile electronic device (e.g., a “smart watch,” a wearable electronic device, a fitness/health tracker, etc.), a mobile phone, a digital media player, or any other appropriate electronic device.

The client device 102-1 typically includes one or more CPUs 204, a user interface 206, at least one network communications interface 212 (wired and/or wireless), an image capture device 214, a positioning system 216, a biometric capture device 217, memory 218, and at least one communication bus 202 for interconnecting these components. Each communication bus 202 may include circuitry (sometimes called a chipset) that interconnects and controls communications between system components. In some implementations, the user interface 206 includes a display 208 and input device(s) 210 (e.g., keyboard, mouse, touchscreen, keypads, etc.).

The image capture device 214 is any device that is capable of capturing an image of a real-world scene or object. In some implementations, the image capture device 214 is a digital camera (including any appropriate lens(es), sensor(s), and other components). In some implementations, the image capture device is a scanner (e.g., a flatbed document scanner). In some implementations, the image capture device 214 is incorporated into a common housing with the client device 102-1. For example, where the client device 102-1 is a mobile phone, the image capture device 214 is a digital camera built into the mobile phone. As another example, where the client device 102-1 is a laptop computer, the image captured device 214 is a digital camera built into the laptop computer (e.g., a “webcam”). Other possible image capture devices include 3-D scanners, 3-D cameras, range cameras, motion sensing imaging devices, ultrasonic scanners, and the like.

In some implementations, the image capture device 214 is in a different housing than the client device 102-1. In one example, the client device 102-1 is a laptop or desktop computer, and the image capture device 214 is a separate scanner or camera that is able to be coupled to the client device 102-1 to provide images to the client device (e.g., via wired connection, such as a wired network connection or a Universal Serial Bus connection, or via a wireless connection, such as WiFi, Bluetooth, or the like).

The positioning system 216 includes devices and/or components for determining the location of the client device 102-1, including but not limited to global positioning system (GPS) sensors, radio receivers (e.g., for cell-tower triangulation, WiFi-based positioning, etc.), inertial sensors, and accelerometers. In some implementations, the client device 102-1 does not include (or does not rely on) a separate positioning system 216. For example, where the client device 102-1 is connected to the Internet (e.g., via the network communications interface 212), the location of the client device 102-1 can be determined using IP address geolocation techniques. Other techniques for determining the location of the client device, including those that rely on an inbuilt or connected positioning system and those that do not, are also contemplated. In some implementations, location may be defined by the network being connected to (e.g., in an airplane, or train or building) or other sensor information which might identify location.

The biometric capture device 217 includes devices and/or components for capturing biometric data from a person. In some implementations, the biometric capture device 217 is a fingerprint scanner. In some implementations, it is a retinal scanner. In some implementations, it is a facial scanner. In some implementations it is a voice recognition scanner. In some implementations, the biometric capture device 217 is a multi-purpose capture device that can capture multiple types of biometric data from a user (e.g., handprints, fingerprints, facial images, etc.). In some implementations, In some implementations, the biometric capture device 217 is a peripheral device (i.e., is not in the same housing as other components of the client device 102-1), and communicates with the client device 102-1 via one or more communication links, including, for example, BLUETOOTH, WiFi, or any other appropriate wired or wireless communication link(s).

Memory 218 includes high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. Memory 218 may optionally include one or more storage devices remotely located from the CPU(s) 204 (e.g., a network-connected storage device or service, such as a “cloud” based storage service). Memory 218, or alternately the non-volatile memory device(s) within memory 218, includes a non-transitory computer readable storage medium. In some implementations, memory 218 or the computer readable storage medium of memory 218 stores the following programs, modules and data structures, or a subset thereof:
an operating system 220 that includes procedures for handling various basic system services and for performing hardware dependent tasks;
a communication module 222 that is used for connecting the client device 102-1 to other computers via the one or more network communication interfaces 212 (wired or wireless) and one or more communication networks, such as the Internet, other Wide Area Networks, Local Area Networks, Personal Area Networks, Metropolitan Area Networks, VPNs, local peer-to-peer and/or ad-hoc connections, and so on;
a user interface module 224 that receives commands and/or inputs from a user via the user interface 206 (e.g., from the input device(s) 210, which may include keyboard(s), touch screen(s), microphone(s), pointing device(s), and the like), and provides user interface objects on a display (e.g., the display 208);
an image capture device module 226 (including, for example, applications, drivers, etc.) that works in conjunction with the image capture device 214 to capture images, such as images or scans of physical documents, faces, real-world scenes, etc.;
a biometric capture device module 227 that works in conjunction with the biometric capture device 217 (and/or the image capture device 214) for capturing biometric data of a user, including data relating to any appropriate physical and/or biological characteristic of a user;
a positioning system module 228 that, in conjunction with the positioning system 216, determines a current location (e.g., latitude and longitude, street address, city, state, municipality, etc.) of the client device 102-1; and
one or more client application module(s) 230 for enabling the client device 102-1 to perform the methods and/or techniques described herein, the client application module(s) 230 including but not limited to:
   an account generation/confirmation module 231 for generating an account with a service provider, including receiving information about a user of the client device 102-1 (e.g., name, address, social security number, password, account recovery questions/answers, biometric data, login credentials, etc.), providing this information to a remote device (e.g., the server 104) in order to create a unique user account, and interacting with the remote device to establish the user's account; the account generation/confirmation module 231 also facilitates user confirmation of account information that was provided to a remote device (e.g., the server 104) by another entity (e.g., a bank), as described herein;
   a data extraction module 232 for extracting information from documents obtained by the client device 102-1, including extracting computer-readable text from documents, using optical character recognition to recognize and extract non-computer readable text from documents, as well as locating and extracting photographs, images, holograms, laser perforations, signatures, bar codes, Quick Response (QR) codes, etc., and the like;
   a biometric analysis module 234 for analyzing biometric data, including determining whether sample biometric data matches reference biometric data (e.g., for user authentication purposes), determining whether a photograph of a user extracted from a document matches a captured photograph of the user (e.g., a photograph captured by the image capture device 214), determining whether a voice sample matches a prior approved voiceprint of the user etc.;
   a document analysis module 236 for analyzing documents (and/or information, photographs, or other content extracted from documents), for example, to determine whether and/or to what degree information extracted from the document matches other information associated with the user (such as the user's name, date of birth, address, etc.), the quality of content extracted from the document (e.g., holograms, laser perforations, etc.), and the like;
   a verification rating module 238 for generating ratings for users, documents, and transactions;
   an encryption/upload module 240 for encrypting documents, biometric data, verification ratings, extracted data, and the like, and uploading such information (either encrypted or unencrypted) to a remote device (such as the server 104);
   a request handling module 242 for receiving requests for information (e.g., from the server 104, a requesting device 108-n (e.g., a third party), and/or another client device 102-n), providing prompts to a user of the client device 102-1 (e.g., via the user interface 206), receiving partial or full authorizations or denials of the requests from the user, and responding to the requests with appropriate responses (e.g., by communicating with the server 104, a requesting device 108-n, and/or another client device 102-n); and
   an authorization management module 244 for enabling a user to view, manage, grant, change, and/or modify authorizations, including revoking previously granted authorizations, consents, or acknowledgments;
   a PII permissions management module 246 for receiving user preferences relating to PII permissions, including what third parties may receive/access PII, what PII may be received/accessed by third parties, when PII may be received/accessed by third parties, how third parties may contact the user, what third parties may contact the user, when third parties may contact the user, etc., and for assigning permissions to one or more context profiles;
   a context profile selection module 248 for receiving user selections of an active context profile and for detecting triggers for automatically selecting an active context profile; and
   a web browser module 250 (e.g., Internet Explorer or Edge by Microsoft, Firefox by Mozilla, Safari by Apple, or Chrome by Google) for accessing, viewing, and interacting with webpages/websites.

In some implementations, the request handling module 242 and/or the authorization management module 244 render code associated with a system agnostic widget (e.g., widget 115, FIG. 1B). For example, the request handling module 242 renders the code associated with the widget 115 to prompt the user (e.g., display a GUI of the widget 115). In another example, the authorization management module 244 renders the code associated with the widget 115 to enable the user to view authorizations. In some implementations, the web browser module 250 is also utilized to render the code associated with the widget. Interaction between the widget and the client device 102-1 is discussed in further detail below with reference to method 900.

In some implementations, the client device 102-1 includes a subset of the components and modules shown in FIG. 2. Moreover, in some implementations, the client device 102-1 includes additional components and/or modules not shown in FIG. 2.

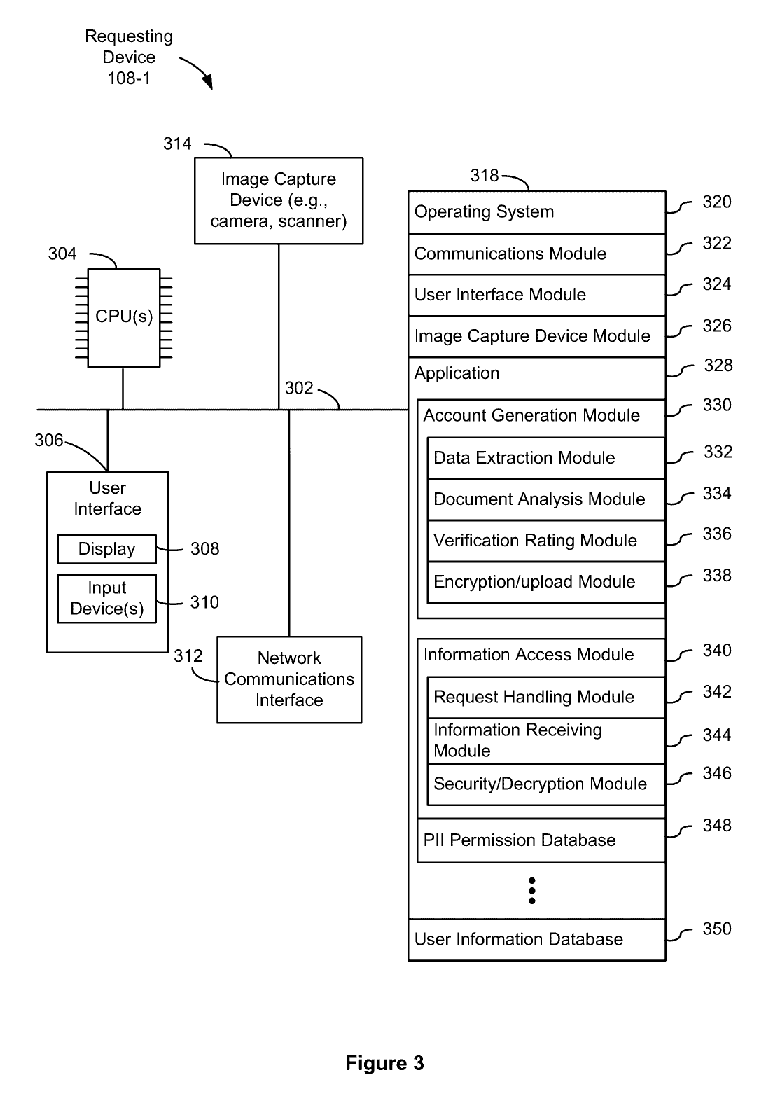

FIG. 3 is a block diagram illustrating a requesting device 108-1, in accordance with some implementations. While FIG. 3 illustrates one instance of a requesting device (i.e., requesting device 108-1), the figure and associated description applies equally to any requesting device (e.g., 108-1-108-n).

In some implementations, the requesting device 108-1 is any of: a desktop computer, a laptop computer, a tablet computer, a server computer (or server system), a mobile electronic device, a mobile phone, a digital media player, or any other appropriate electronic device (or a kiosk housing any of the aforementioned devices).

The requesting device 108-1 typically includes one or more CPUs 304, a user interface 306, at least one network communications interface 312 (wired and/or wireless), an image capture device 314, memory 318, and at least one communication bus 302 for interconnecting these components. Each communication bus 302 may include circuitry (sometimes called a chipset) that interconnects and controls communications between system components. In some implementations, the user interface 306 includes a display 308 and input device(s) 310 (e.g., keyboard, mouse, touchscreen, keypads, etc.).

The image capture device 314 is any device that is capable of capturing an image of a real-world scene or object. In some implementations, the image capture device 314 is a digital camera (including any appropriate lens(es), sensor(s), or other components). In some implementations, the image capture device is a scanner (e.g., a flatbed scanner). In some implementations, the image capture device 314 is incorporated into a common housing with the requesting device 108-1. In some implementations, the image capture device 314 is incorporated into a common housing with the requesting device 108-1, or in a connected or external device capable of rendering image capture for the user (e.g., a drone etc.).

Memory 318 includes high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. Memory 318 may optionally include one or more storage devices remotely located from the CPU(s) 304. Memory 318, or alternately the non-volatile memory device(s) within memory 318, includes a non-transitory computer readable storage medium. In some implementations, memory 318 or the computer readable storage medium of memory 318 stores the following programs, modules and data structures, or a subset thereof:
an operating system 320 that includes procedures for handling various basic system services and for performing hardware dependent tasks;
a communication module 322 that is used for connecting the requesting device 108-1 to other computers via the one or more network interfaces 312 (wired or wireless) and one or more communication networks, such as the Internet, other Wide Area Networks, Local Area Networks, Personal Area Networks, Metropolitan Area Networks, VPNs, local peer-to-peer and/or ad-hoc connections, and so on;
a user interface module 324 that receives commands and/or inputs from a user via the user interface 306 (e.g., from the input device(s) 310, which may include keyboard(s), touch screen(s), microphone(s), pointing device(s), and the like), and provides user interface objects on a display (e.g., the display 308);
an image capture device module 326 (including, for example, applications, drivers, etc.) that works in conjunction with the image capture device 314 to capture images, such as images or scans of physical documents, faces, real-world scenes, etc.
one or more application module(s) 328 for enabling the requesting device 108-1 to perform the methods and/or techniques described herein, the application module(s) 328 including but not limited to:
   one or more account generation module(s) 330 for generating accounts with a service provider for one or more users based on information already in possession of the entity operating the requesting device 108-1 (e.g., information and documents that a user has already shared with an institution), the account generation module(s) 330 including but not limited to:
      a data extraction module 332 for extracting information from information (e.g., documents and/or PII) obtained by the requesting device 108-1, including extracting computer-readable text from documents, using optical character recognition to recognize and extract non-computer readable text from documents, as well as locating and extracting photographs, images, signatures, holograms, laser perforations, bar codes, Quick Response (QR) codes, etc., and the like;
      a document analysis module 334 for analyzing documents (and/or information, photographs, or other content extracted from documents), for example, to determine whether and/or to what degree information extracted from the document matches other information associated with the user (such as the user's name, date of birth, address, etc.), the quality of content extracted from the document (e.g., holograms, laser perforations, etc.), and the like;
      a verification rating module 336 for generating verification ratings for documents; and
      an encryption/upload module 338 for encrypting documents, biometric data, verification ratings, extracted data, user information (e.g., name, address, social security number, etc.) and the like, and uploading such information (either encrypted or unencrypted) to a remote device (such as the server 104); and
   one or more information access module(s) 340 for handling requests for user information and handling information received pursuant to those requests, the information access module(s) 340 including but not limited to:
      a request handling module 342 for receiving requests from an operator of the requesting device 108-1 (and/or automatically generated requests) for user information, and for communicating the requests for user information to remote devices (e.g., such as the server 104 and/or a client device 102-n);
      an information receiving module 344 for receiving information associated with a user (e.g., from the server 104 and/or from a client device of the user), including but not limited to documents, data extracted from documents, verification ratings, etc., and for receiving decryption keys (e.g., from the server 104 and/or a client device 102-n), and personal information (PII) associated with a user; and
      a security/decryption module 346 for determining access rights to information associated with a user and for decrypting information associated with a user; and
   a personal information consent database 348 for storing and managing previously granted consents; and
a user information database 350 for storing user information (e.g., received from the server 104), including but not limited to documents, data extracted from documents, verification ratings, decryption keys, PII, and the like.

In some implementations, the request handling module 342 communicates with the system agnostic widget (e.g., widget 115, FIG. 1B). For example, the request handling module 342 may include an interface associated with the widget 115 which may be used to (as discussed above with reference to FIG. 1B) communicate information to the widget 115. In another example, the request handling module 342 communicates information to the widget 115 in a message.

In some implementations, the requesting device 108-1 includes a subset of the components and modules shown in FIG. 3. Moreover, in some implementations, the requesting device 108-1 includes additional components and/or modules not shown in FIG. 3.

FIG. 4 is a block diagram illustrating a server 104, in accordance with some implementations. In some implementations, the server 104 is any of: a desktop computer, a laptop computer, a tablet computer, a server computer (or server system), a mobile electronic device, a mobile phone, a digital media player, or any other appropriate electronic device (or a kiosk housing any of the aforementioned devices).

The server 104 typically includes one or more CPUs 404, a user interface 406, at least one network communications interface 412 (wired and/or wireless), memory 414, and at least one communication bus 402 for interconnecting these components. Each communication bus 402 may include circuitry (sometimes called a chipset) that interconnects and controls communications between system components. In some implementations, the user interface 406 includes a display 408 and input device(s) 410 (e.g., keyboard, mouse, touchscreen, keypads, etc.).

Memory 414 includes high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. Memory 414 may optionally include one or more storage devices remotely located from the CPU(s) 404. Memory 414, or alternately the non-volatile memory device(s) within memory 414, includes a non-transitory computer readable storage medium. In some implementations, memory 414 or the computer readable storage medium of memory 414 stores the following programs, modules and data structures, or a subset thereof:
an operating system 416 that includes procedures for handling various basic system services and for performing hardware dependent tasks;
a communication module 418 that is used for connecting the server 104 to other computers via the one or more network interfaces 412 (wired or wireless) and one or more communication networks, such as the Internet, other Wide Area Networks, Local Area Networks, Personal Area Networks, Metropolitan Area Networks, VPNs, local peer-to-peer and/or ad-hoc connections, and so on;
a user interface module 420 that receives commands and/or inputs from a user via the user interface 406 (e.g., from the input device(s) 410, which may include keyboard(s), touch screen(s), microphone(s), pointing device(s), and the like), and provides user interface objects on a display (e.g., the display 408);
one or more server application module(s) 422 for enabling the server 104 to perform the methods and/or techniques described herein, the server application module(s) 422 including but not limited to:
   an account generation module 424 for generating accounts for users based on information provided (and/or verified) by the users or by other entities, and storing the accounts (and associated information) in the user account database 106;
   a receiving module 426 for receiving information from remote devices (e.g., client devices 102-n, requesting devices 108-n), including but not limited to: documents, PII, verification ratings, data extracted from documents, account information (e.g., name, address, social security number, password, account recovery questions/answers, biometric data, login credentials, etc.), evidence of identity, etc.;
   an optional encryption module 428 for encrypting user information (including but not limited to transaction data, documents, verification ratings, data extracted from documents, account information) for secure storage in the user information database 106, if the user information was not encrypted before it was received by the server 104;
   a request handling module 430 for receiving and processing requests for information associated with respective users (e.g., from a requesting device 108-n), sending authorization requests to the respective users (e.g., to a client device 102-n), and receiving authorizations from the respective users (e.g., to allow access to the requested information or a subset or superset of the requested information);
   an information packaging/encrypting module 432 for gathering, packaging, and encrypting user information (including but not limited to documents, verification ratings, data extracted from documents, account information) to be sent to or otherwise accessed by a requestor (e.g., a requesting device 108-n), and for sending the information to the requestor; and
   an access management module 434 for determining whether to allow requesting entities to access user information (e.g., based on permissions granted and/or denied by the respective users, time limits imposed by users and/or regulatory agencies, or any other appropriate permissions, limits, criteria, etc.);
a user information database 106 that includes information associated with a plurality of users; and
a certificate generation module 446 for generating certificates, such as those described with respect to FIG. 7.

FIG. 4 further illustrates a portion of the user information database 106 relating to a user account 436 for an exemplary user “n.” The user account 436 includes but is not limited to:
account information 438 associated with the user (e.g., name, address, social security number, password, account recovery questions/answers, biometric data, login credentials, etc.);
document(s) and/or other PII 440 associated with the user, including any appropriate documents, files, containers, data/content extracted from documents, etc., as well as archived sets of the above information and/or documents, enriched sets of documents (e.g., made by updating existing documents with subsequent updated/revised versions of the same document);
verification rating(s) 442, including verification ratings for all or a subset of the document(s) 440, composite verification ratings (e.g., verification ratings based on a plurality of tests), a user score, and the like; and
permission data 444, including active and historical permissions (e.g., authorizations, consents, denials, etc.) granted by a user for requesting or authorized entities, as well as digital representations of information associated with the permissions granted by the user (e.g., digital representations captured by the system agnostic widget 115, FIG. 1B).

In some implementations, the request handling module 430 includes a profile based PII gateway 116 (e.g., PII gateway 116, FIG. 1B). In some implementations, the PII gateway 116 is used for receiving information requests and/or communications directed to client devices from third parties (e.g., requesting device 108-1, FIG. 3), for receiving responses from client devices, and for forwarding communications from third parties to client devices and vice versa. In some implementations, the PII gateway 116 performs the operation above based on user's active context profile and associated permissions.

In some implementations, the request handling module 430 includes a system agnostic widget (e.g., widget 115, FIG. 1B). Alternatively, in some implementations, the widget is a distinct module stored in memory 414 and performs some or all of the tasks performed by the request handling module 430. For example, the widget is used for receiving information from the requesting device 108-1 (e.g., via an interface associated with the widget), creating one or more GUIs using the information received from the requesting device 108-1 (e.g., creating multiple versions of a consent request using the information received from the requesting device 108-1), and receiving authorization (or denial) from the client device 102-1. In addition, in some embodiments, the widget includes one or more features (e.g., a capture feature). It should be understood that the widget may service multiple requesting devices and multiple client devices. The widget is discussed in further detail below with reference to method 900.

In some implementations, the memory 414 also includes the certificate database 110 for storing certificates, such as those described with respect to FIG. 7.

In some implementations, any or all of the user information in the user information database 106 and certificate database 110 is encrypted. Moreover, in some implementations, the service provider does not possess decryption keys for the user information or certificates. Accordingly, in some implementations the service provider and/or the server 104 is not able to decrypt, view, read, or modify user information or certificates. In other implementations, users of the system can view certificates but not modify them, e.g., there is no mechanism for users to edit the original certificate stored in the certificate database 110.

In some implementations, the server 104 includes a subset of the components and modules shown in FIG. 4. Moreover, in some implementations, the server 104 includes additional components and/or modules not shown in FIG. 4.

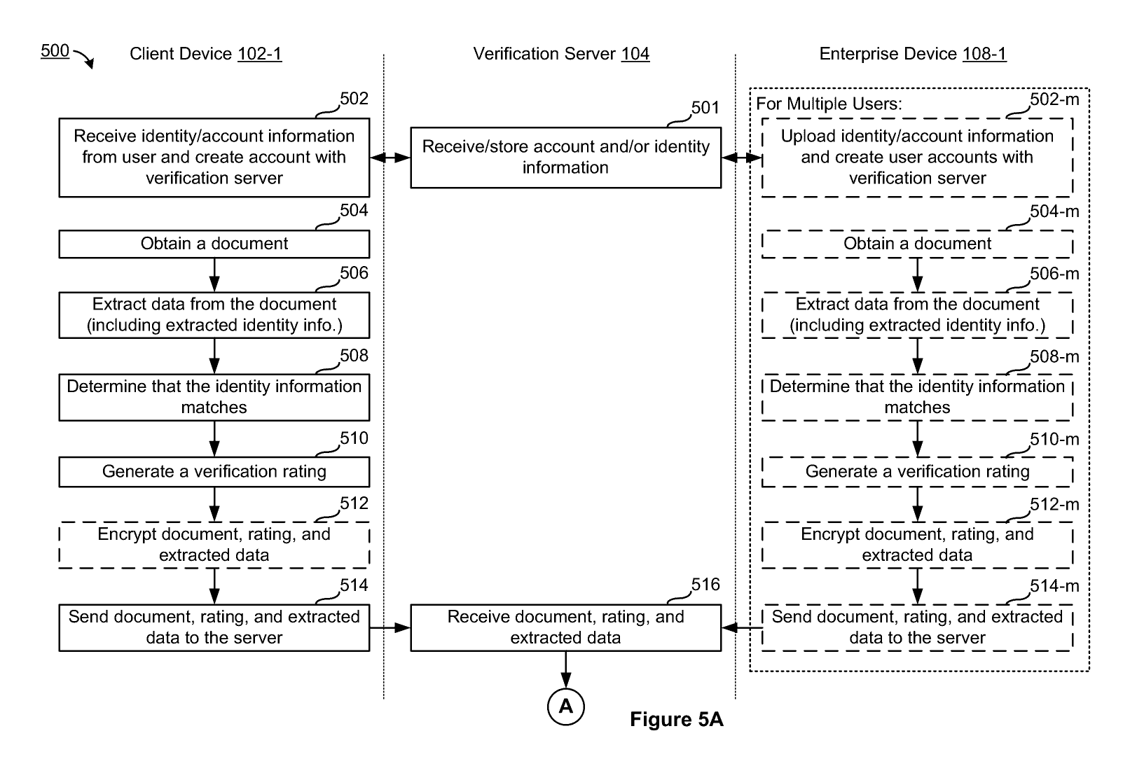

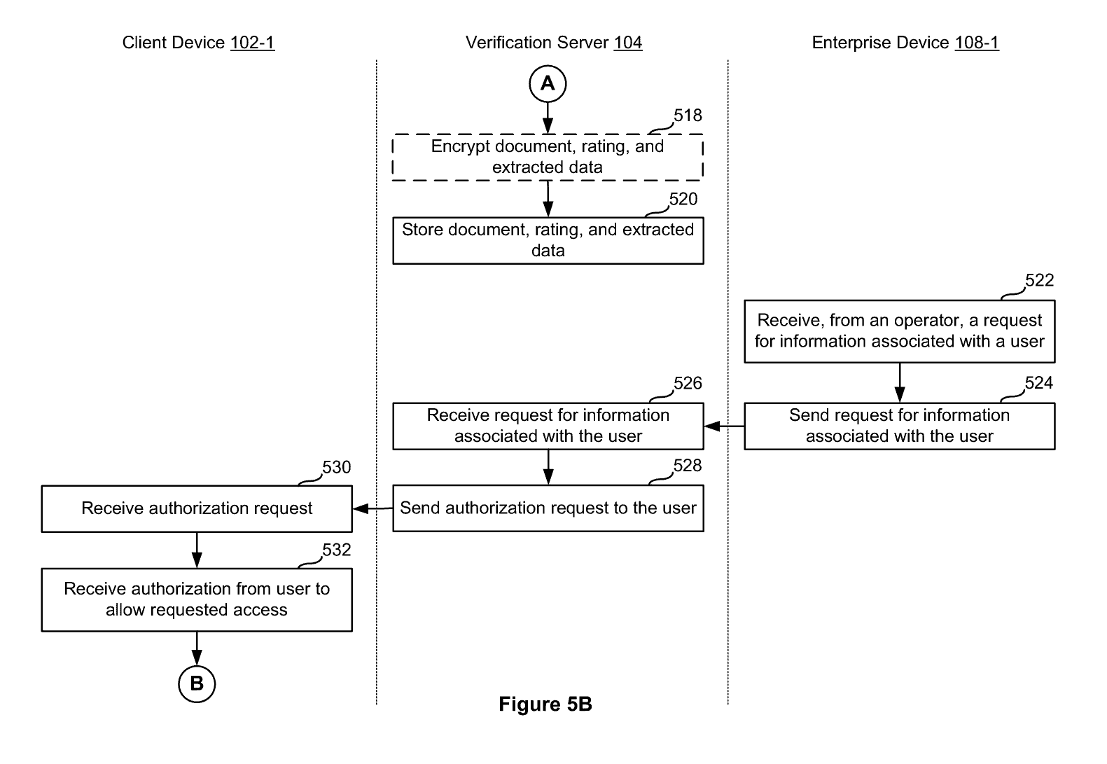

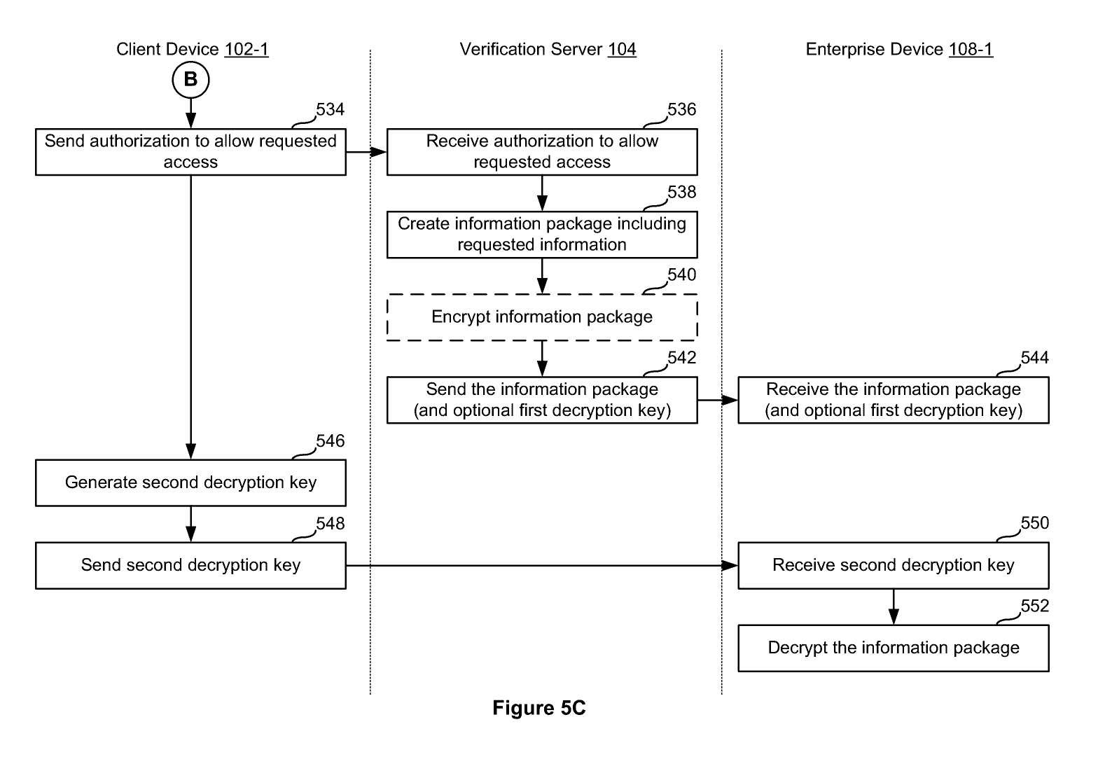

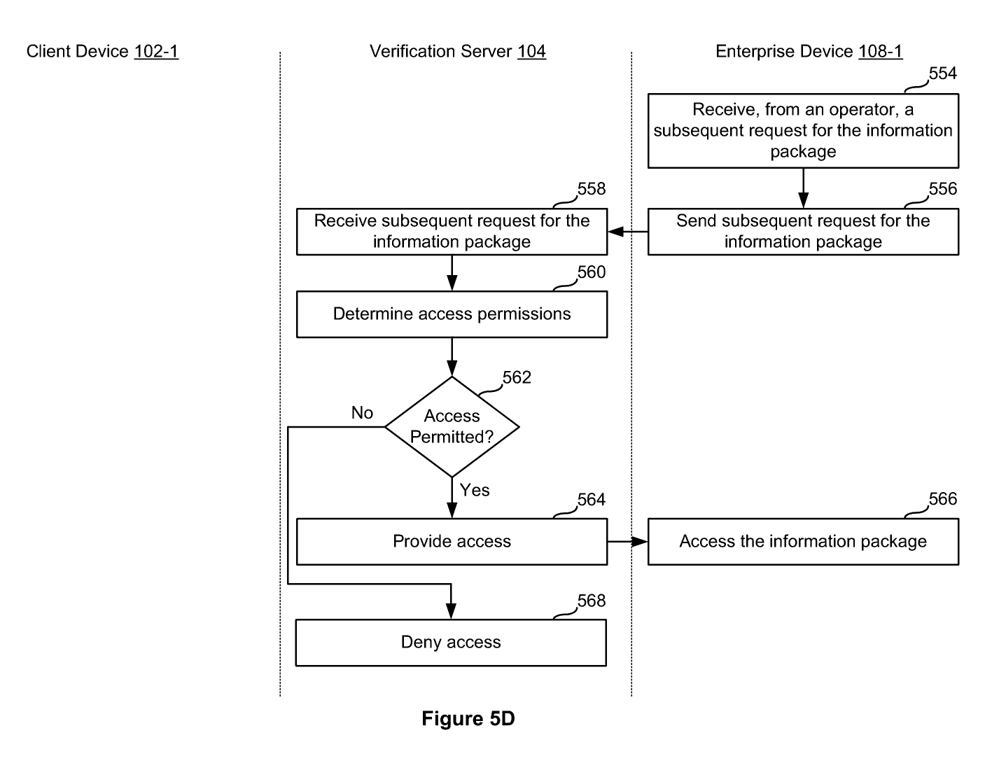

FIGS. 5A-5D are flow diagrams illustrating a method 500 for sharing verified identity documents, in accordance with some implementations. Each of the operations shown in FIGS. 5A-5D may correspond to instructions stored in a computer memory or computer readable storage medium. In some implementations, the steps are performed at an electronic device with one or more processors (or cores) and memory storing one or more programs for execution by the one or more processors (or cores). For example, in some implementations, the steps are performed at any one (or any combination) of the client device 102-1, the server 104, and the requesting device 108-1. Moreover, the individual steps of the method may be distributed among the multiple electronic devices in any appropriate manner.

Any or all of the communications between devices described with respect to FIGS. 5A-5D are, in some implementations, secured and/or encrypted using any appropriate security and/or encryption techniques, including but not limited to Hypertext Transport Protocol Secure (HTTPS), Secure Sockets Layer (SSL), Transport Layer Security (TLS), Secure Shell (SSH), Internet Protocol Security (IPSec), public key encryption, and the like (including any appropriate yet to be developed security and/or encryption method).

An account is created with a service provider (502) (e.g., with the account generation/confirmation module 231). In some implementations, as part of creating the account (i.e., account enrollment/registration), a user provides to the client device 102-1 identity information, such as a name, gender, date of birth, address, social security number, residency, etc. In some implementations, the user provides login information, such as a username, password, and identity verification questions/responses (e.g., mother's maiden name, father's middle name, city of birth, etc.) In some implementations, the user provides other information as well, such as: a signature (e.g., a photograph/image of a signature, or a signature input directly into the client device 102-1, such as with a touch-sensitive screen and a stylus), a photograph, a username, a fingerprint biometric, a voiceprint biometric, a facial biometric, a zip code, and an account number.

The client device 102-1 communicates with the server 104 to register the user account, which includes the server 104 receiving and/or storing account information and/or identity information provided by the user (501) (e.g., with the account generation module 424).

The client device 102-1 obtains a document (504). Documents obtained by the client device 102-1 from a user are provided to requesting entities to help verify the user's identity. Exemplary documents include drivers' licenses, national identity cards, birth certificates, passports, social security cards, marriage certificates, utility bills, government issued photo identification cards, and the like. In the present discussion, documents are any appropriate type of digital file, including computer-readable, text-based files (e.g., word processing files, spreadsheet files, computer-generated bills, etc.), or images of physical documents (e.g., scans, digital photographs, etc.), either of which can be stored as or represented in any appropriate file type, file format, etc. (e.g., PDF files, JPEG files, GIF files, TIFF files, DOC files, etc.). Moreover, where the term “document” is used, the corresponding discussion may relate to a computer-readable version of a document, a physical version of a document, or both, depending on the context of the discussion. One of ordinary skill in the art will recognize where the discussion relates to computer-readable versions of a document and where the discussion relates to physical versions of a document.

In some implementations, the document is obtained by capturing a digital image of a physical document (e.g., with the image capture device 214 and/or the image capture device module 226). For example, where the client device 102-1 is a mobile phone with a built-in camera, the user takes a snapshot of a document using the camera. As another example, where the client device 102-1 is a laptop or desktop computer connected to a flatbed scanner, the user obtains a scan of the document using the scanner.

In some implementations, the document is obtained by retrieving it from the memory of an electronic device. For example, documents may be stored as a digital file in memory associated with and/or otherwise available to the client device 102-1. Accordingly, a user can point the client application 230 to a particular document by navigating to the file via a file browser, or directly entering a memory location (e.g., file path) of the file. The client device 102-1 then obtains the document from the specified location.

The client device 102-1 extracts data from the document (506) (e.g., with the data extraction module 232). In some implementations, extracted data includes identity information (e.g., name, address, phone number, social security number, etc.).

In some implementations, extracted data includes text data. Text data is extracted either directly from documents having computer-readable text, or extracted after performing optical character recognition on an image of a document (or both). In some implementations, extracted data includes biometric data, for example, from a photograph contained in the document. Biometric data is extracted using facial or other biometric recognition/extraction techniques. Other data may be extracted as well, including images of a signature, images of the user, other images, holograms, laser perforations, bar codes, QR codes, etc.

The client device 102 then determines that the identity information extracted from the document substantially matches the identity information associated with the user's account (508) (e.g., with the document analysis module 236). For example, the extracted identity information (e.g., the name extracted from a drivers' license) is compared to the user's account (e.g., the name that the user supplied when creating the account) to confirm that the document is associated with the account holder (i.e., the information on the two documents matches or substantially matches). Thus, if a user attempts to upload someone else's drivers' license, the client device 102-1 recognizes that the document is not associated with the user, and can reject the document, reduce or adjust a verification rating for that document, flag the document, request corroborating or additional information, or take other remedial actions.

In some implementations, the client device 102-1 performs one or more additional tests of the document (e.g., with the document analysis module 236). For example, in some implementations, the client device 102-1 determines whether a dated document (e.g., a utility bill or any other document having an issue date, mailing date, expiration date, due date, etc.) was issued within a predetermined recency window with respect to the current date (e.g., 30, 60, or 90 days, or any other appropriate window). As another example, in some implementations, the client device 102-1 identifies, from the data extracted from the document, an expiration date of the document, and determines whether the expiration date of the document is after a current date (i.e., the document has not expired). In these examples, the current date may be determined by referencing a system date of the client device 102-1, or calling out to a remote device or service (e.g., the server 104, a telecommunications service) and receiving a current date. Such tests can help ensure that a user does use old or outdated documents, which may be an indicator that the information contained thereon is not accurate. Other tests may also be performed.

In some implementations, the client device 102-1 determines whether a system date of the client device substantially matches a reference date provided by a remote device. This test can help identify attempts to tamper with the system date of the client device 102-1, which may be attempted by users to enable them to upload a document that is out-of-date or expired. If the system date of the client device does not substantially match the reference date, remedial measures can be taken. For example, the client device 102-1 and/or the server 104 will prevent the user from uploading the document, adjust a verification rating for the document, flag the user's account for further review or scrutiny, or the like.

In some implementations, if the document meets the criteria of the additional tests, the document is permitted to be uploaded to the user's account, and if the document does not meet the criteria of the additional tests, the document is rejected and cannot be uploaded to the user's account. In other implementations, the document is uploaded to the user's account regardless of whether the criteria are met, but the verification rating (discussed below) is adjusted or otherwise reflects whether or not (or the degree to which) the criteria are satisfied.

The client device 102-1 then generates at least one verification rating for the document (510) (e.g., with the verification rating module 238). The verification rating, discussed in greater detail below, indicates a degree of confidence that the document is authentic and/or is actually associated with the user. In particular, the accuracy of identity verification is limited by the level of trust that can be placed on the authenticity of the documents. For example, a fraudulent drivers' license or passport cannot be trusted to accurately identify the person who is presenting it. Accordingly, the client device 102-1 performs one or more tests on the document (i.e., the image of the document) to determine its authenticity and whether it actually identifies the user. One specific example of such a test is a comparison between biometric data in a photograph on the document and biometric data in a photograph of the user captured by the client device 102-1, which is performed by the biometric analysis module 234. If it is determined that a face in the photograph from the document matches the recently captured photograph of the user, there is a higher likelihood that the drivers' license is associated with the person in the photograph, and the verification rating will reflect this higher confidence (e.g., with a relatively higher rating). On the other hand, if the faces do not match (or if they match to a lesser degree), then the verification rating will reflect this lower confidence (e.g., with a relatively lower rating).

In some implementations, verification ratings are generated by the client device 102-1 alone. Thus, the documents, which contain sensitive identity information, do not leave the possession of the user. In some implementations, if other devices are used to assist in generating verification ratings (e.g., the server), any information sent to the other devices is encrypted, obfuscated, and/or stripped of any identifying information, so that the user's privacy and the security of the documents is maintained.

In some implementations, the client device 102-1 encrypts the document, the extracted data, and the verification rating (512) (e.g., with the encryption/upload module 240). The client device 102-1 then sends the document, extracted data, and the rating (e.g., one or more encrypted data files) to the server 104 at step (514) (e.g., with the encryption/upload module 240).

In some implementations, the client device 102-1 generates one or more containers (i.e., containers) including any combination of the document, the extracted data, and the verification rating, and sends the container(s) to the server 104 at step (514). In some implementations, containers are collections of individual files (e.g., a zip file). In some implementations, containers are complex data structures that include information from which one or more different files and/or documents (including, for example, an image of a document, data extracted from a document, and the like) can be extracted or constructed, even though the files and/or documents are not represented in the containers as discrete files.

In some implementations, the one or more containers include at least a first file that includes the document and a second file that includes the information extracted from the document. In some implementations, the one or more containers include a third file that includes the at least one verification rating. In some implementations, the at least one verification rating includes a plurality of verification ratings (e.g., including a verification rating for each document in the one or more containers, composite verification ratings, a user score, etc.). (Where the container is a complex data type, the container includes data from which such files and/or information can be extracted/constructed, as discussed above.)

In some implementations, the client device 102-1 performs steps (504)-(514), or a subset thereof, for one or more additional documents. For example, images of multiple documents are captured (504), and, for each document, the client device 102-1 extracts data (506), determines that the identity information matches (508), generates a verification rating (510), encrypts the document, rating, and extracted data (512), and sends these items to the server (514). In some implementations, these multiple documents are combined in the container for sending to the server.

The server 104 receives the document, extracted data, and the rating (516) (e.g., with the information receiving module 342, FIG. 3). In some implementations, these items are received as a container, as described above.

In some implementations, user accounts are assigned a status, which reflects particular information about the account, and determines how the account and/or the information and documents associated with the account can be used. In some implementations, the status of an account reflects whether the account includes a required amount and/or type of documents and user information, or whether the account is deficient in one or more areas. In some implementations, if the account includes the required documents and/or information, its status is “complete,” and if the account is deficient in one or more ways, its status is “pending.” Other statuses, and other labels for the described statuses, are also assigned to accounts in various implementations.

In some cases, an account is considered “complete” if it includes a government issued photo identification document and a utility bill, as well as a name and address of the user. In other implementations, more or fewer documents or items of information are required in order for an account to be considered complete. The particular documents and/or information that amount to a “complete” account is, in some cases, determined based on regulations, laws, guidelines, or customs of an applicable jurisdiction. In some implementations, the jurisdiction is a jurisdiction of the account holder, a jurisdiction of an institution or entity that is requesting the documents/information, a jurisdiction governing a transaction between an account holder and a requesting institution or entity, or any other appropriate jurisdiction or combination of jurisdictions.

In some cases, an account is considered “pending” if the account lacks particular documents or items of information that are required of a “complete” account. An account can also be assigned a “pending” status based on other conditions. For example, an account can be “pending” if a document or item of information is expired or otherwise out of date. As a specific example, if a passport associated with a user account becomes expired after it is uploaded to the user's account, the account is assigned a “pending” status. As another example, if there is no recent utility bill (e.g., mailed/issued within 90 days of a current date) associated with the account, the account is assigned a “pending” status. Other conditions can also cause an account to be assigned a “pending” status, in various implementations.

In some implementations, only a “complete” account can be used by a user to share documents with other parties. Thus, if a user's account is “pending,” the user must provide the missing document(s), information, or perform the required tests (discussed herein) in order to complete the account before the user can authorize other parties to access his or her documents and/or information.

The foregoing discussion describes how users create accounts and upload documents with the client device 102-1. In particular, the client device 102-1, along with one or more modules in the memory 218, performs steps (502) through (514). In some cases, however, other users of the system can create accounts for other users. For example, an institution may decide to use a service provider to access identity verification information for individuals or other entities with whom the bank transacts. Accordingly, the institution may wish to create accounts for some or all individuals for whom it already has identity information, identification documents, and the like. Accordingly, in some implementations, a requesting device 108-1 includes an account generation module 329 for creating accounts for multiple users. In particular, the requesting device 108-1 uses the account generation module 329 to perform steps (502-m) through (514-m). Steps (502-m) through (514-m) are analogous to steps (502) through (514), and are performed using modules analogous to those modules of the client device 102-1 that perform those steps on the client device, as described above (e.g., including the data extraction module 330, the document analysis module 332, the verification rating module 334, and the encryption/upload module 336, FIG. 3).

While an institution can create an account for a user, in some implementations, until the account is complete (i.e., contains all the information and/or documents required to establish a complete account), or until the user approves the account and the information and/or documents associated with the account, the account is given a “pending” status. Once the institution and/or the user complete the account (e.g., by providing any missing information and/or documents, and/or by approving information and/or documents uploaded by the institution), the account is given a “complete” status.

In some implementations, accounts created for users by an institution are not uploaded to the service provider (i.e., the server 104) until the user associated with the account has approved and/or completed the account. This way, the server 104 does not need to store and/or manage incomplete and/or pending accounts that will never be completed and/or approved by a user (e.g., because the user does not wish to or has no need to establish the account, or any other appropriate reason). Instead, account information for such accounts is stored in memory associated with the requesting device 108-1 (e.g., the user information database 346).

Turning to FIG. 5B, in implementations where the document, verification rating, and extracted data were not encrypted by the client device 102-1 (or the requesting device 108-1) prior to being sent to the server 104, they are encrypted by the server 104 for storage (518) (e.g., with the encryption module 428).

The server 104 stores the document, extracted data, and the verification rating (520) (e.g., in the user information database 106). In some implementations, where the information is encrypted on the client device 102-1 prior to being sent to the server 104, the server 104 is unable to decrypt the information. Accordingly, users can be assured of the privacy and security of their information, while institutions (and other requesting entities) can be assured that the information has not been tampered with or otherwise altered (or even viewed) by the service provider.

When an institution wishes to access the documentation and/or information necessary in order to verify the identity of an individual, an operator uses the requesting device 108-1 to request information associated with the individual, and the requesting device 108-1 receives this request (522) (e.g., with the request handling module 340). In some implementations, the user requests a particular set of documents and information (i.e., distinct information items associated with the user account). For example, a bank may request information such as the user's name, home address, social security number (all of which may be stored by the service provider as part of the user's account information), as well as an image of the user's drivers' license and a recent utility bill and verification ratings for those documents.

In some implementations, the information requested 522 by the requesting device (e.g., a bank) is simply an authorization, consent or acknowledgment from the client device.

In some implementations, the request includes access limits relating to the scope of the access that is to be granted to the requestor, such as a window of time in which the requestor will be permitted to access the information, the number of times that the requestor will be permitted to access the information, etc. In some implementations, the requestor includes such information in its request to the server 104. For example, a bank may request a user's drivers' license and recent utility bill, and specify that it needs to access this information only once. Alternatively, a bank may request this information and specify that it needs to access updated copies of it at any time (and as many times as desired) while the account remains open and/or for a specified length of time (e.g., as specified by a user). Other appropriate access limits or time windows (or any other constraints on access to the information) are envisioned as well.

The requesting device 108-1 then sends the request for the information to the server 104 at step (524) (e.g., with the request handling module 340).

The server 104 receives the request for information associated with the account of the user (e.g., the information including at least one of a document, data extracted from a document, and at least one verification rating; or the information including a request for authorization) from the requesting device 108-1 at step (526) (e.g., with the request handling module 430), and sends a request to the client device 102-1 requesting authorization (e.g., to release the requested information to the requestor) (528) (e.g., with the request handling module 430). In some implementations, the client device 102-1 provides a notification or alert indicating that a request has been received or is available to be viewed. In some implementations, the notification or alert is or is included in an email, text message, application alert, or any other appropriate message using any appropriate messaging technique or protocol. In some implementations, the server 104 sends the notification or alert to the client device 102-1 before sending the request to the client device 102-1, and the request is sent to the client device 102-1 once the user logs in to his or her account via the client device 102-1 (e.g., in response to the notification or alert).

The client device 102-1 receives the authorization request (530). The user securely logs onto the client device and can then review the request. The client device 102-1 then prompts the user to partially or fully authorize or deny access to the requested information (e.g., with the request handling module 242) or provide authorization or consent. If the client device 102-1 receives authorization from the user (532), it sends an authorization to the server 104 (e.g., to release the authorized information to the requestor) (534, FIG. 5C) (e.g., with the request handling module 242). In some implementations, the authorization request that is presented to a user identifies particular documents and/or information being requested. Furthermore, in some implementations, the authorization request identifies the access limits (or lack thereof) requested by the requestor. For example, as described above, the request may state that a bank has requested access to the user's drivers' license and a utility bill, and that they want to be able to view (or download an updated copy of) the documents at any time while the user has an account with the bank, or for any other specified time. Thus, in some implementations, the user is able to determine whether or not to allow access according to the request.

In some implementations, the information requested and/or the access limits are non-negotiable. For example, a bank may be required by law to maintain records of certain information of the entities with which it transacts. Accordingly, should the user deny access to that information, the bank will be unable to engage in the subject transaction (e.g., opening a bank account, line of credit, etc.).

On the other hand, in some implementations, the information requested and/or the access limits are negotiable and/or selectable by the user. For example, a bank may request access to more information and/or fewer access limits than are strictly necessary for a particular transaction or relationship. The user can then refuse to authorize the full scope of the request, and instead authorize access to fewer or different documents and/or information, as well as different access limits. In some implementations, the user is informed of any minimum access requirements necessary for a particular transaction so that the user can make an informed decision as to what access limits to allow.

In some implementations, a request includes multiple different authorization request packages, each including a different combination of requested documents, information, authorizations, consents, and/or access limits, and the user selects which authorization request package to approve. Here too, the user can be informed of the minimum document and access requirements necessary for the requesting entity to be able to engage in a particular transaction.

Continuing on FIG. 5C, the server 104 receives the authorization to release the information to the third party (536) (e.g., with the request handling module 430).

The server 104 then creates an information package including the requested information (538) (e.g., with the information packaging/encrypting module 432). For example, the server 104 locates the requested documents, extracted data, verification ratings, etc., and, if necessary, extracts/constructs these items from a container. The information package is any appropriate file, container, composite file, or group of separate files that contain the requested information.

In some implementations, the server 104 encrypts the information package (540) (e.g., with the information packaging/encrypting module 432). In some implementations, the information that constitutes the information package is already encrypted (e.g., having been encrypted by the client device 102-1, the server 104, or the requesting device 108-1 prior to being stored in the user information database 106). In some implementations, client-based encryption can only be decrypted by a key generated by and/or known to the client device 102-1. Accordingly, in some implementations, the server 104 does not encrypt the information package at this stage.

However, in some implementations, the server 104 encrypts the already-encrypted information again at step (540). This secondary encryption can be used to enable and/or enforce access limits by providing an encryption layer that is controlled by the server 104. For example, as described herein, the requesting device 108-1 may have to receive authorization from the server 104 each time it wants to view the information that it receives, even if the information is stored locally on the requesting device 108-1. Accordingly, the requesting device 108-1 communicates with the server 104 in order to obtain the necessary permissions (and/or decryption keys or codes) before it can access the information.

Returning to FIG. 5C, the server 104 sends the information package to the requesting device 108-1 (542) (e.g., with the information packaging/encrypting module 432). In some implementations where the server 104 encrypted the information (540), the information package is sent with a first decryption key that is able to decrypt the information package. On the other hand, in some implementations, the first decryption key is not included with the information package even if it was encrypted by the server at (540). In such cases, the requesting device 108-1 receives the decryption key at a later time, such as when an operator of the requesting device attempts to access and/or view the information.

In some implementations, the information package merely includes an authorization or consent together and other optional information, such as a verification rating, transaction rating, etc.

In some implementations, the requesting device 108-1 receives the information package, and the optional first decryption key (544) (e.g., with the information receiving module 342). In some implementations, the requesting device 108-1 stores the information package in a local database 346, for example, to satisfy record keeping requirements and regulations. Even when the information is stored in a local database, in some implementations, the requesting device 108-1 cannot view the information without first communicating with the server 104 to determine whether it is permitted to do so, as discussed herein.

As noted above, if the user approves a request for information, the client device 102-1 sends an authorization message to the server 104 (534). In some implementations, if the user approves the request for information (or a subset or superset of the information), it also generates a second decryption key for decrypting the requested information (546) (e.g., with the encryption/upload module 240). In some implementations, the decryption key is generated prior to receiving the authorization request.

In some implementations, the client device 102-1 must generate the decryption key, because it is the only device that can do so. That way, view access to the information remains under the control of the user, and only the user and entities authorized by the user can decrypt and view the information.

In some implementations, the client device 102-1 sends the second decryption key to the requesting device 108-1 (e.g., with the encryption/upload module 240). The requesting device 108-1 receives the second decryption key (550) (e.g., with the information receiving module 342).

In some implementations, the requesting device 108-1 then decrypts the information package (552) (e.g., with the security/decryption module 344). In some implementations, decrypting the information includes first decrypting the information package using the first decryption key (to remove the encryption applied by the server 104), and then decrypting the information contained in the information package with the second decryption key (to remove the encryption applied by the client device 102-1).

Turning to FIG. 5D, the requesting device 108-1 receives, from an operator, a subsequent request for the information package (554) (e.g., with the request handling module 338), and sends the subsequent request for the information package to the server 104 (556) (e.g., with the request handling module 338). In some implementations, the subsequent request for the information package is a request for all of the information that was in the original request. In other implementations, the subsequent request includes a request for only a subset of the information in the original request.

Moreover, requests may also specify that the information should include the most up-to-date versions of the requested information. Thus, if the user has uploaded a new drivers' license or utility bill since the information was previously received, the new information will be provided (subject to the access permissions associated with the original request). On the other hand, the request may also specify that the information should include the information as it was at the time of the original request. In some implementations, whether a requesting entity is permitted to access updated versions of documents and information (or whether they are only permitted to access the versions available at the time of the original request) is specified in the access permissions discussed with respect to steps (524)-(532).

The server 104 receives the subsequent request for the information package (558) (e.g., with the request handling module 430), and determines access permissions (560) (e.g., with the access management module 434). For example, the server 104 determines whether the subsequent request is permitted by the original authorization from the user. The access permissions include content permissions (e.g., whether the requestor is permitted to access a particular document, rating, or other information), and/or time/frequency permissions (e.g., whether the request satisfies time window and/or access frequency limits imposed by the user).

If access is permitted (562—Yes), then the server 104 provides access to the requested information (564). In some implementations, providing access (564) includes packaging, encrypting, and sending the requested information to the requesting device 108-1 as in steps (538)-(544). In some implementations, providing access (564) includes providing a decryption key (or other access token) to enable the requesting device 108-1 to decrypt or otherwise access information that is already stored by the requesting device 108-1 (e.g., in the user information database 346). The requesting device 108-1 then accesses the information package (566).

If access is not permitted (563—No), then the server 104 denies access to the requested information (568) (e.g., with the access management module 434).

As noted above, verification ratings are generated for documents obtained by the client device 102-1 or by the requesting device 108-1. Verification ratings are based on, derived from, or otherwise reflect the results of one or more tests. Verification ratings, in some implementations, indicate a degree to which a document is authentic and/or actually relates to a particular user. As an example, a document that appears to be a forgery will likely have a lower rating than a document that does not appear to be a forgery. As another example, a document that appears to be expired will likely have a lower rating than one that is still valid. As yet another example, a document that appears to indicate an address that is different than the user's current location will likely have a lower rating than one that has an address falling at or near the user's current location. Because verification ratings can reflect the results of various different tests and/or characteristics, the foregoing descriptions of how test results affect the verification rating are merely exemplary, and are not necessarily dispositive of how any particular verification rating will be affected by the various results. For example, a document that has a high likelihood of being a forgery, but all of the information on the document is otherwise correct (e.g., a name and address on the document match the user's account information, and a photograph on the document is a biometric match to a photograph of the user) may actually have a higher rating than a document that does not appear fraudulent, but includes information that does not match that of the user's account (e.g., the name, address, and biometric information indicates that the document does not relate to the user at all).

In some implementations, each of a plurality of tests performed on or for a document results in a distinct verification rating, and all of the verification ratings for the document are combined to create a composite verification rating for the document. The composite verification rating is generated in any appropriate manner, including using an average (e.g., an arithmetic mean, weighted mean, etc.) of the verification ratings generated by each respective verification test, an algorithm, or any other appropriate combination of verification ratings and/or other information (e.g., summing the results of each test).

Verification ratings for each test employ any appropriate rating or scoring scale. For example, in some implementations, verification ratings use a numeric scale, such as 1-100, 1-10, 1-5, or any other appropriate range (e.g., a letter grade range, such as A-F, A-Z, etc.). Such scales are used for tests that produce a range of results and/or indicate a level or degree of satisfaction of one or more criteria. As one specific example, a test that determines the extent to which a photograph extracted from a document matches a reference photograph of a user can be rated using a scale (e.g., based on the matching algorithm, a rating of 100% indicates a good match, 70% indicates a partial match, 0% indicates a low or zero likelihood of match).

In some implementations, verification ratings are binary or “pass/fail” (which may be indicated in any way, such as with a check mark or green circle for pass, and an “X” or a red circle for fail). In such cases, whether a document is assigned a pass or a fail rating is based on any one or more tests of the document and/or its contents. Specific examples of tests are described herein.

In some implementations, tests result in both a “pass/fail” rating and a numerical rating (e.g., between 1 and 100). In some implementations, whether a test results in a pass or fail rating is based on the numerical rating (e.g., lower than 50 out of 100 results in a fail).

Moreover, in some implementations, composite verification ratings are generated for documents. The composite verification rating is based at least partially on a plurality of verification ratings from a plurality of tests (as described herein). Composite verification ratings are created from any appropriate combination of the verification ratings from individual tests. For example, a composite verification rating can be an average of individual verification ratings, or an additive rating (e.g., each individual rating is based on a 0-10 scale, and the composite rating is the sum of all individual ratings).

In some implementations, a “user score” is generated for a user's account, based at least in part on the verification ratings (and/or composite verification ratings) of the documents associated with a user. In some implementations, the user score is also or instead based on other information, such as the completeness of a user account, third party identity verifications/corroborations, etc.

In some implementations, the user score also reflects the various types of documents that have been provided by a user. For example, if a user provides documents that were not issued by a government (e.g., utility bills, student identification cards, credit cards, etc.), the user score will be lower than if the user has provided government issued documents (e.g., a passport, drivers' license, etc.).

As noted above, various tests can be applied in various implementations to generate verification ratings. Exemplary tests are discussed below. Each test may affect the verification rating in various ways. For example, some tests result in a qualitative analysis of a document, such as a confidence value, a quality value, a rating, or the like. In such cases, verification ratings may be at least partially based on and/or reflect the results of the qualitative analysis. For example, in some implementations, a verification rating is scaled based on the results of the qualitative analysis, such that a lower result reduces the verification rating for a document, and a higher result increases (or does not affect) the verification rating.

Some tests result in a quantitative and/or discrete result, such as whether or not a match is determined, whether or not an expected result is found, or the like. Similarly, in some cases, qualitative analysis results are compared against threshold conditions, resulting in a discrete result (e.g., the threshold condition is either satisfied or it is not). In some implementations, discrete results reduce and/or increase a verification rating, depending on the result (e.g., a failed test reduces a verification rating by a predetermined amount). In some implementations, discrete results act as a threshold for acceptance of the document. For example, if a document does not satisfy a particular threshold (e.g., an expected watermark is absent), the document is rejected and no verification rating is provided for the document (e.g., because it is likely that the document is fraudulent).

The tests described herein can be combined in any appropriate way. For example, in some implementations, some tests are used to generate a numerical verification rating, while others are used to determine whether to accept or reject a document (e.g., pass/fail conditions). Moreover, verification ratings for documents are sometimes described as being “based on” the results of one or more of the following tests. As used herein “based on” means either “exclusively based on” (i.e., based only on), or “at least partially based on.”

Address Confirmation

In some implementations, residency and/or address information extracted from documents is compared against location information of the user. In particular, in order to confirm that a user actually resides at the address shown on a document, the address from the document is compared against the current location of the user's device (e.g., as determined by GPS, cell-tower triangulation, IP address geolocation, or the like). In such cases, the verification rating of the document is based at least partially on whether or the degree to which the address matches the current location of the user's device.

Different levels of precision can be used for address confirmation, depending on the particular application or use case. For example, in some cases, it is desired to determine the country of residence of a user. Accordingly, it is not necessary that the user's address exactly match the user's current location. Rather, it is enough that the user's current location is anywhere within the country identified by the user's address. In other cases, it is desired to determine that the user actually lives at the location identified by the user's address. In such cases, it is necessary to determine that the user's current location is within a predetermined distance of the user's address, such that it is likely that the user actually lives at that address. For example, in some implementations, a user's current location is determined to match a purported address if the current location is within 100 feet of a location associated with the user's address (e.g., latitude and longitude values associated with the address). Other distances are also contemplated (e.g., 500 feet, 1000 feet, 1 mile, 5 miles, 10 miles, or any other appropriate distance).

In addition to comparing the user's actual location with the location from a given document, in some implementations, a user score is based on the consistency of the addresses of multiple of a user's documents. In particular, if all of the user's documents are associated with a same location (e.g., a same address, city, state, region, country, etc.), the user score will be higher. Moreover, in some implementations, verification ratings of individual documents reflect whether the address of that document matches addresses of other documents. For example, if a user's passport and drivers' license specify one address, and a user's utility bill specify a different address, then the verification rating for the utility bill (and/or the passport or drivers' license) will reflect the discrepancy (e.g., by lowering the rating for that document or rejecting that document altogether). The client device 102-1 also, in some implementations, looks up an address associated with the user in a separate database in order to compare to an address on one or more documents and/or a current location of the client device 102-1. For example, the client device 102-1 retrieves an address for a user from a credit score database, from online address resources (e.g., yellow or white pages), from a social media portal, etc.

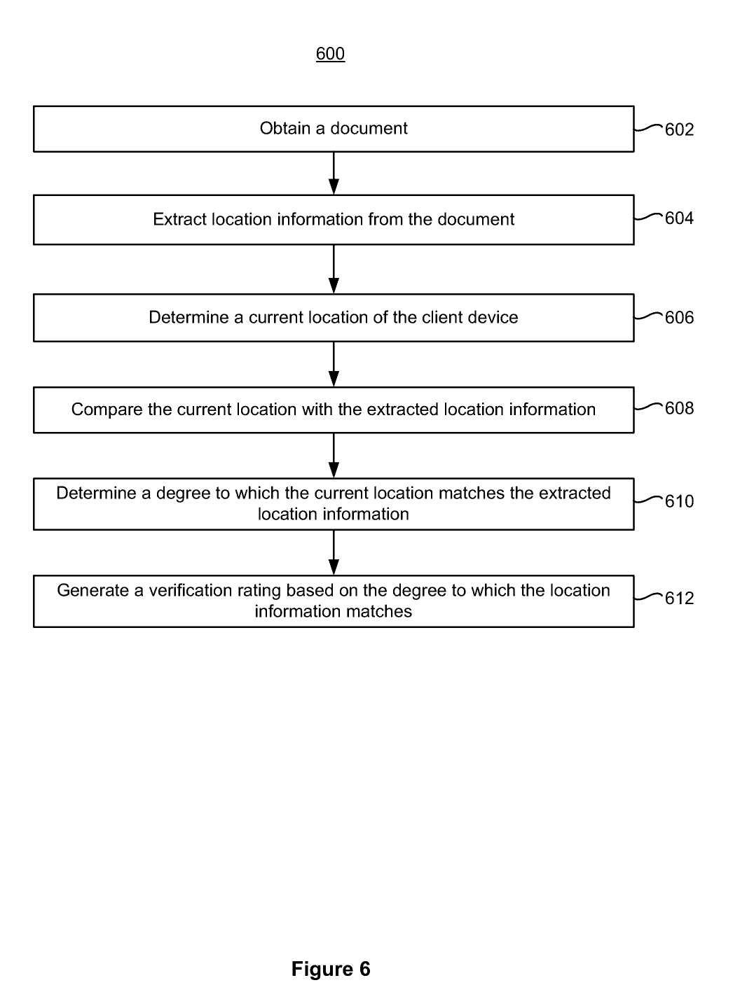

FIG. 6 is a flow diagram illustrating a method 600 for verifying a document based on the user's current location, in accordance with some implementations. Each of the operations shown in FIG. 6 may correspond to instructions stored in a computer memory or computer readable storage medium. In some implementations, the steps are performed at an electronic device with one or more processors (or cores) and memory storing one or more programs for execution by the one or more processors (or cores). For example, in some implementations, the steps are performed at any one (or any combination) of the client device 102-1, the server 104, and the requesting device 108-1. Moreover, the individual steps of the method may be distributed among the multiple electronic devices in any appropriate manner.

The client device 102-1 obtains a document (602) (e.g., with the image capture device module 226). Additional details related to obtaining documents are discussed above with respect to step (504) of FIG. 5A.

The client device 102-1 extracts data from the document, the extracted data including extracted location information (604) (e.g., with the data extraction module 232). Extracted location information includes, for example, an address included in the document (e.g., a mailing label, an address field of an identification document, etc.), country of residence information (e.g., extracted from a drivers' license or passport number or country code, etc.), and the like.

The client device 102-1 determines a current location of the client device (606) (e.g., with the positioning system module 228). In some implementations, the current location of the user's device is determined using GPS, cell-tower triangulation, IP address geolocation, or the like.

The client device 102-1 compares the current location of the client device with the extracted location information (608) (e.g., with the document analysis module). The client device 102-1 determines a degree to which the current location of the client device matches the extracted location information (610) (e.g., with the document analysis module).

In some implementations, as described above, the degree to which the current location of the client device matches the extracted location information is a pass/fail result: if the current location is within a predetermined distance of the extracted location information, the locations are determined to match; if the current location is beyond the predetermined distance, the locations are determined not to match. Also, the resolution of the extracted location information is selected according to the particular application. For example, in some cases, it is only necessary or desired to determine that the user is in the state, region, or country indicated by an address extracted from a document. In other cases, it is necessary or desired to determine that the user is within a predetermined distance of the actual address extracted from the document.

In some implementations, the client device 102-1 generates a verification rating based on the degree to which the current location of the client device matches the extracted location information (612) (e.g., with the verification rating module 238). In some implementations, instead of (or in addition to) determining the degree to which the current location of the client device matches the extracted location information, the client device 102-1 determines the degree to which a historical record of locations of the client device 102-1 matches the extracted location information. For example, the client device 102-1 prompts a user to allow access to historical location information (e.g., for a certain time period, such as 1 year), and if the user allows access, the client device 102-1 determines how long or how frequently the client device 102-1 was at or near the location identified by the extracted location information, and generates or adjusts the verification rating based thereon.

In some implementations, the client device 102-1 generates a verification rating based on the degree to which the current location of the client device matches a historical set of extracted location information (e.g., the degree to which the current location matches the address information extracted from a plurality of previously uploaded documents).

Photograph Comparison

Documents that include photographs (e.g., drivers' licenses, passports, government issued photo identification cards, etc.) are analyzed to determine whether the photograph in the document matches a photograph of the user. In some implementations, a user provides one or more reference photographs of him or herself. The reference photographs can be captured by an imaging device associated with a client device (e.g., a smartphone camera, a webcam or a scanner coupled to a computer, etc.), or uploaded to the client device (e.g., received as a digital image file in some other way). In some implementations, references photographs are captured from different angles, with different facial expressions, and with different lighting, in order to increase the quality of the photographic analysis.

The photograph from the document is then compared to the reference photograph(s) to determine if they substantially match. The comparison uses facial recognition techniques, such as comparing, between the photograph from the document and the reference photograph biometric information such as: the structure, shape, and proportions of the face; the absolute and/or relative location of the nose and eyes; the distance between the eyes, nose, mouth, and jaw; the upper outlines of the eye sockets; the sides of the mouth; and the area surrounding the cheek bone. Biometric information is extracted from the document photograph and the reference photograph.

In some implementations, the user captures a photograph that includes both their face and the document that contains a photograph. The user's face is then compared to the photograph in the document using one or more of the above techniques (or a technique not listed) to determine whether the photograph matches the user, and the verification rating is based at least in part on a degree of match between the biometric information from the photograph of the user and the biometric information from the reference photograph

In some implementations, a confidence value that the individuals in both photographs are the same is calculated based on one or more photographic analysis techniques, including but not limited to those listed above. In some implementations, the confidence value is reflected in a verification rating for a document that contains the photograph.

In some implementations, multiple reference photographs of a user are captured. For example, a client may be asked to capture photographs of themselves from different angles, under different lighting conditions, with or without glasses or other obstructions, with different facial expressions, or the like. In some implementations, a device walks a user through the process of obtaining a certain set of photographs, for example, using visual and/or audio prompts (e.g., showing images or graphics of exemplary photographs, etc.).

In some implementations, in order to facilitate comparison between photographs, a device includes components and/or application modules for performing imaging techniques, such as image rectification, creation/calculation of depth maps, calculation of reflectivity, and the like.

Security Feature Analysis

Some documents include security features such as watermarks, holograms, ghost photos/images, optically variable inks, and/or pigments that are sensitive to and/or reflect certain types of illumination and/or radiation. For example, many government issued photo identification documents (e.g., drivers' licenses, passports, etc.) include such security features. In order to detect and/or capture a suitable photograph of these items, the documents need to be exposed to appropriate types of radiation while the photograph is captured. In some implementations, users are prompted to capture one or more photographs of such documents while exposing it to a particular type of radiation or radiation source.

In some implementations, users capture an image of a document while exposing the document to an infrared radiation source (e.g., a remote control for a television, stereo, DVD player, or the like). In some implementations, users capture an image of a document while exposing the document to an ultraviolet radiation source (e.g., ultraviolet daylight bulbs, ultraviolet flashlights, “black lights,” etc.).

For documents that include holograms, users capture a series of photographs or a short video while a camera flash is on (e.g., a flash incorporated with a cell-phone camera). In some implementations, the flash is controlled (e.g., by an application module) so that different flash outputs are used for different photographs. Reflectivity values for the hologram across the series of photographs or short video are analyzed to determine that they satisfy a particular condition (e.g., that the difference in reflectivity between given images substantially conforms to an expected value).

Some documents include text and/or images that must be viewed through a polarizing filter in order to be successfully analyzed. In such cases, users capture an image of the document through a polarizing filter, such as polarized sunglasses or a polarized photographic filter.

Some documents include laser perforations. In order to detect such perforations (which are often so small that they cannot be detected when the document is front-lit), the user captures a photograph of the document under back-lit conditions (e.g., held up to a light bulb) so that the laser perforations can be detected. The laser perforations are then analyzed to determine their quality and/or whether they match an expected pattern or content. In some implementations, the expected content of a laser perforation depends on the issuing authority of the document (e.g., the country that issued a passport).

Some security features do not require special radiation and/or illumination for accurate photographic analysis, such as rainbow and/or guilloche printing. In some implementations, a user captures a photograph of a document that includes rainbow and/or guilloche printing, and the printing is analyzed to determine its presence and/or quality. In some implementations, the quality of rainbow and/or guilloche printing is based on the resolution, colors, detail, shape, or size of the printing, or whether it matches an expected pattern and/or content (and/or any other appropriate metric). In some implementations, verification ratings are based on and/or reflect the quality and/or presence of the security features described above.

Zone Comparison

Some documents include multiple different zones, where one zone includes the same and/or a subset of the information in one or more other zones. For example, passports include a “visual zone” and a “machine-readable zone.” The “visual zone” lists certain information, such as the user's name, address, passport number, and the like in a format that is easily readable by a human. The “machine-readable zone” includes information such as the user's name, passport number, date of birth, country, etc., in a format that is easily readable by a machine.

In some implementations, photographs of documents having multiple zones are analyzed to determine whether the information in the various zones match. For example, a user captures a photograph of a document that includes multiple zones. Optical character recognition (“OCR”) is then performed (using any suitable OCR technique) on all or a subset of the zones (e.g., the “visual zone” and the “machine-readable zone” of a passport), and the information contained in the zones is compared. In some implementations, verification ratings are based on and/or reflect the degree to which information in each of the multiple zones match.

In some implementations, a “machine-readable zone” includes a bar code or other non-alphanumeric character based content, and, therefore, is not suited to OCR techniques. In such cases, the content of the “machine-readable zone” is analyzed using any appropriate technique, such as decoding a bar code using appropriate code-reading techniques.

Document Presence Tests

Some tests are designed to confirm that the user is in the presence of the actual document in question. For example, a user captures a series of photographs of different pages of a document (e.g., a passport) within a certain time frame. Successfully providing the requested images of the requested pages within the time frame corroborates that the user is in the presence of the actual document.

As another example, a user captures a photograph of the user holding the document in front of a mirror. As yet another example, a user captures a video recording showing the user holding the document. As yet another example, a user captures a photograph of a most recent stamp in a passport. The ability of the user to provide such images/videos corroborates that the user is in the presence of the actual document (e.g., as opposed to a copy of the document or only a single page of the document).

As yet another example, a user is prompted to capture photographs of a document in accordance with certain criteria. Specifically, the user is prompted to capture photographs of a document in certain orientations, positions, angles, and the like. The ability of the user to capture the requested images suggests whether the user is in the presence of the actual document.

In some implementations, a reticle is displayed on a viewfinder of an imaging device (e.g., on a screen of a smartphone or digital camera) that specifies an orientation of the document. The user must then capture an image according to the specified orientation. For example, the reticle is a trapezoid, and the user must orient the document and/or the camera such that the document fits within and/or substantially matches the shape of the reticle. In some implementations, the specific orientations, positions, or angles requested are determined in a pseudo-random manner, so that a user cannot easily predict what photographs will be requested.

In some implementations, a user captures photographs of paper-based documents against a substantially transparent surface (e.g., a glass window). For paper documents, the light illuminating the back surface causes the document to appear translucent, allowing any printing or content on the back of the page to become at least partially visible. Accordingly, the photograph is analyzed to determine the content and/or quality of content on the back surface of the document (i.e., the document surface that is against the transparent surface), and/or to evaluate the level, consistency, or quality of translucence of the paper itself.

Issuing Party Confirmation Tests

Some tests confirm whether a particular document embodies or includes parameters or patterns expected of a document issued by a particular issuing party. For example, passport numbers for a certain country may conform to a detectable pattern. If the parameters or patterns do not match expected ones (e.g., based on the user's self reported information, or based on other information extracted from the document), then the authenticity of the document may be suspect.

In some implementations, a user captures a photograph of the center pages of a passport, and the threading pattern of the passport binding (visible in the center pages) is compared against a known threading pattern for the purported country or issuing party/jurisdiction of the passport.

In some implementations, a user captures a photograph of a portion of a document that contains a unique identifier (e.g., a passport number, drivers' license number, etc.), and the number is compared against a known pattern for the purported country, state, or issuing party/jurisdiction of the document.

Depth Analysis

Three-dimensional analysis of a document (and/or a document in conjunction with one or more other objects) is also used in some implementations to determine that the document is authentic. For example, in some implementations, a user captures several directional point-of-view photographs of a document. As another example, a user captures one or more photographs of a document with extraneous objects placed over it. Verification ratings for these documents reflect a calculation of depth based on image rectification techniques.

Physical Trait Tests

Some documents are made of materials that have unique properties. For example, drivers' licenses are typically made of a plastic or composite that has a certain rigidity and/or stiffness. Accordingly, some tests are designed to determine whether the document is likely made of an expected material. Specifically, in some implementations, a user captures a photograph in which he or she is bending a document (e.g., a drivers' license). The photograph can be analyzed to determine whether the document conforms to an expected curvature, or otherwise appears to be made of an expected material (e.g., a plastic card rather than a slip of paper).

Information Corroboration Tests

In some implementations, a verification rating for a document is also based on whether or the degree to which information from the document matches information from another source. For example, as noted above, the other source of information can be user-entered information (e.g., information provided by a user during an account enrollment process). In some implementations, the other source of information is another document. For example, a verification rating for a drivers' license is based at least in part on the degree to which the information in the drivers' license matches information extracted from a passport.

As a specific example, certain drivers' licenses are issued with both a plastic card and a paper slip (e.g., drivers' licenses in the United Kingdom and the European Union). In these cases, the verification rating for a drivers' license is based on whether or the degree to which the information on the plastic card matches the information on the paper slip. Moreover, for such two-part documents, the verification rating is also based on whether or not the paper slip can be provided. In some implementations, no verification rating is provided for such document if the second part of the document cannot be photographed.

Signature Comparison

In some implementations, users are required or requested to sign documents before capturing photographs of them. Such signatures are then compared to a reference signature associated with the user. The verification rating is then based on whether or the degree to which the signature matches the reference signature. Reference signatures are, for example, provided by the user during an account enrollment process (e.g., entered by a user via a touchscreen or touchpad input device), or extracted from another document (e.g., drivers' license, passport, etc.). In some implementations, documents that must be signed include utility bills.

In some implementations, a video is captured of a user signing a document. The video is then analyzed to determine whether the user signed the document within an acceptable time frame (e.g., less than 5 seconds, or any other appropriate time frame), and whether the resulting signature sufficiently matches a reference signature. This can help detect fraudulent or forged signatures, as it may be difficult for a user to quickly produce a convincing forgery.

Third Party Review

In some implementations, third parties can verify and/or corroborate information and/or documents of other users. For example, notaries, lawyers, or other authorized individuals can review information submitted by a user and provide an analysis and/or opinion about the documents and/or the user. In some implementations, such analysis and/or opinion is reflected in a verification rating of a document or a user score. In other implementations, it is independent of a verification rating or user score (e.g., it is a separate indication that the account has been verified by a third party). In some implementations, the third party is provided with physical versions of documents for review (e.g., copies or originals are delivered to the third party).

In some implementations, third parties are other users of the service who personally corroborate the identity claims of other users. For example, a first user who personally knows a second user can corroborate the second user's identity, which can increase a verification rating and/or user score of the second user, or appear as a separate indication that the account has been corroborated by another user. In some implementations, the first user's verification rating(s), account status, and/or user score is affected if the users and/or accounts that they corroborate turn out to be falsified, fraudulent, or otherwise suspect. For example, a user score of the corroborating user can be reduced, their account can be degraded to a “pending” status, or their account can be rejected by the service provider altogether.

Also, where corroboration by a first user affects a verification rating or user score of a second user, the verification ratings and/or corroboration history of the first user can affect the amount by which the second user's verification rating or user score is changed. For example, if a user with a high user score (the first user) corroborates the identity of the second user, the second user's score can be increased more than it would be if the first user had a lower user score.

Any of the tests described above can be performed on any appropriate device, depending on the implementation. For example, in some implementations, they are performed on a client device 102-1 (e.g., as part of a document upload process performed by a user). In some implementations, they are performed on a requesting device 108-1 (e.g., as part of an account generation process performed on behalf of individuals by an institution, using documents already in the possession of the institution). In some implementations, they are performed on a server 104 (e.g., after they have been uploaded by a client device 102-n or a requesting device 108-n).

Not all of the tests described above are necessarily applied to all documents. Rather, one of skill in the art will recognize that some tests are not applicable to certain documents or types of documents. For example, a photograph comparison tests (e.g., comparing a photograph from a document to a reference photograph of a user) would not apply to documents that do not include photographs of the user. Similarly, hologram analysis tests would not apply to documents that do not include holograms. In some implementations, the tests that can be performed on a particular document depend on the type of document.

Moreover, not all tests that are suitable for a particular document are necessarily performed on that document. Rather, in some implementations, when a document is uploaded, a certain subset of the suitable tests for that document is selected. The user is then prompted to capture the photographs and/or images required for the selected tests.

In some implementations, when a document is obtained from a user, the subset of tests are selected in a pseudo-random fashion, such that it is difficult for a user to predict what tests will be required for any particular document. Accordingly, it is more difficult for users to create or obtain fraudulent documents (or to capture photographs of someone else's documents) ahead of time if they cannot predict what particular photographs they will be prompted to capture and/or what analysis will be performed on the document.

In some implementations, a user can increase the verification rating for a particular document by electing to perform one or more additional tests. The verification rating is then adjusted based on the results of the additional tests. Specifically, if the results are positive (e.g., support the validity and/or authenticity of the document), the verification rating is increased. On the other hand, if the results are negative (e.g., refute the validity and/or authenticity of the document), the verification rating is decreased.

In some implementations, the number of tests performed on a document is reflected and/or included in the verification rating itself. For example, a document may be amenable to 10 different tests, and the results of each test are scored on a 0-10 scale. Thus, if a document is subjected to 3 tests, and receives a perfect result for each test, the overall verification rating is 30 of a possible 100. Subjecting the document to additional tests can then increase the verification rating, depending on the results of those tests.

On the other hand, in some implementations, the number of tests performed on a document is reflected separately from the verification rating. For example, a verification rating for a document may be a certain value (e.g., 80%) based on the results of a certain number of tests (e.g., 3 of a possible 10), and the number of tests is reported separately from the verification rating. Thus, in this example, the rating of 80% reflects a combined result of the 3 tests that were performed (e.g., an average rating), and does not indicate the number of tests that were performed.

For any of the tests described above, users are prompted with step-by-step instructions, examples, sample images, and/or any other information to assist with the successful completion of the requested tests. Also, any analysis used in any of the tests described above may be fully automatic (without human intervention), fully manual, or a combination of automatic and manual. A facial recognition analysis, for example, can be performed by a computer (e.g., using a facial recognition and/or comparison algorithm), or by a human (e.g., a human operator reviewing a reference photograph and a document photograph and determining whether they match. In some implementations, a human operator reviews the results of an automatic analysis process in order to confirm, reject, and/or modify the results of the analysis.

FIGS. 8A-8C are flow charts of a fraud alert process flow, according to some implementations of the invention. This flow chart illustrates one implementation for addressing a fraud alert issued by a card processor 803. A card processor, or payment processor, 803 is any enterprise that is appointed by a merchant to handle credit or debit card transactions for merchant acquiring banks. The merchant's point-of-sale or POS terminal 801 connects to the card processor 803 to both check the details received from the merchant by forwarding them to the respective card's issuing bank or card association for verification, and also carry out a series of anti-fraud measures to protect against fraudulent transactions. In some implementations, both the card processor 803 and the POS 801 are requesting devices 108(1)-(n) of FIG. 1A that communicate over the network.

In FIGS. 8A-8C, the customer 805 is an individual who has an account with a bank or card issuer. In use, the customer 805 uses their credit or debit card to purchase goods or services at the merchant via the merchant's POS 801. In some implementations, the client 807, shown in FIGS. 8A-8C, is the client device 102(1)-(n) of FIGS. 1A and 2. In some implementations, the database 811 shown in FIGS. 8A-8C is the certificate database 110 of FIGS. 1 and 4. In some implementations, the server 813 shown in FIGS. 8A-8C is the server 104 of FIGS. 1 and 4. The bank or bank agent 815 shown in FIGS. 8A-8C represents a card issuing bank, and, in some implementations, one or more individuals employed by the card issuing bank or other authority that are tasked with approving or denying card transactions.

In use, the customer 805 attempts to purchase goods or services from a merchant's POS 801 at 802. The POS 801 then sends an electronic message to the card processor 803 at 804. This message may be sent over a private or public network (e.g., network 110 of FIG. 1A). This message may include the customer's name, the card number, the issuing bank's name, the expiry date, the transaction amount, a merchant or POS identifier, etc. The card processor 803 receives the message and runs a set of rules against the data contained in the message at 806. In some implementations, these rules are anti-fraud rules designed to detect fraudulent transactions. The card processor then determines whether to automatically deny the transaction at 808, e.g., because the transaction is fraudulent. If it is determined that the transaction should be denied (808—Yes), then a message is sent to the merchant's POS 801 denying the transaction at 810. For example, the transaction is denied because the card has been reported stolen. If it is determined that the transaction should not be denied (808—No), then the card processor runs a set of query rules at 812 to determine whether authorization for the transaction should be requested (e.g., from the issuing bank or from the user). If it is determined that it is not necessary to query the transaction (814—No), then a message is sent back to the POS 801 authorizing the transaction at 816. Although not shown, if a transaction is authorized, known steps are taken to credit the merchant and debit the customer for the transaction amount. The query may include the customer's name, the card number, the issuing bank's name, the expiry date, the transaction amount, a merchant or POS identifier, any further acknowledgments required by the card processor, etc. This query may be sent over a private or public network (e.g., network 110 of FIG. 1A).

If it is determined that it is necessary to query the transaction (814—Yes), then a query is sent from the card processor 803 to the server 813 at 818. In some implementations, the server 813 receives the query and runs its own set of rules at 820. Based on the contents of the query, these rules determine whether approval is required, and if so what type of approval is required, who needs to provide the approval, etc. If approval is not required (822—No), then the server 813 sends a release to the card processor at 826. The card processor 803 in turn authorizes the transaction at 828 based on the received release.

If issuing bank or card authority approval is required (822—Yes), then the server 813 sends a request for such approval to the issuing bank 815 at 824. The bank 815 receives the request, which in some implementations is generally presented to an individual for approval. The bank 815 then responds at 830 with either the necessary approval, or with requirements for what further action is required, e.g., obtaining authorization for the transaction directly from the customer. In some implementations, the action taken by the bank is completely automated and does not require review by an individual. The server 813 receives the response from the bank and sends a temporary hold to the card processor at 834. The card processor may in turn notify the POS 810 of the temporary hold at 832. In some implementations, the card is also blocked at 834, i.e., it is no longer capable of being used for any transactions.

At this time, the certificate generation module 446 (FIG. 4) of the server 813 (104 of FIG. 4) creates a new certificate in the certificate database 811 (e.g., 110 of FIGS. 1A and 4) at 836. The sever 813 also adds a transaction request event (e.g., event 715(1)-(n) of FIG. 7) into the new certificate at 838. Then, the server 813 sends a message to the client 807 (e.g., 102(1)-(n) of FIGS. 1 and 2) requesting an acknowledgement that the transaction is valid at 840. This message may be sent over a private or public network (e.g., network 110 of FIG. 1A). In some implementations, this message contains a list of evidence required by the bank, e.g., a photo identification or answers to challenge questions, as well as a request for acknowledgment that the specific transaction is valid and authorized by the customer using the client device. In some implementations, this message contains a context (e.g., a purpose).

Turning to FIG. 8B, the client then receives the request for an acknowledgment of the transaction, and runs its own set of rules at 842 to determine what is required by the bank. For example, the client application 230 (FIG. 2) might determine that additional evidence is required to verify the user's location and/or identity. The client then displays a request to the customer using the client device at 844. In some implementations, the request asks for additional evidence of identity. In some implementations, the request asks challenge questions. In some implementations, the request simply asks for an acknowledgment that the transaction is valid and/or authorized, or that the current location of the customer is valid and/or authorized for card use.

In some implementations, if additional evidence is required (846—Yes), the customer is asked to provide that evidence at 848. For example, the client device may request that the customer answer one or more challenge questions; may require the customer to take a photograph of themselves, the card, and/or their ID card with a camera on the client device; the customer's biometric data (e.g., a fingerprint collected from one or more sensors on the device); or the like. The customer may then provide the evidence at 850. In some implementations, the client will pause the process until such evidence is provided. In other implementations, further evidence is captured by the device either automatically or with customer approval at 852. For example, the location for the device may be obtained from the positioning system 216 (FIG. 2) and/or the device's IMEI, MAC address, and/or IP address may be captured.

The client also receives an acknowledgement from the customer that the card transaction is valid and/or authorized at 854. In some implementations, this acknowledgment may take the form of a selection of a choice displayed to the customer on a display of the client, e.g., “approve this transaction” or “decline this transaction,” or “approve this location” or “decline this location.”

In some implementations, the client also calculates a transaction rating for the particular transaction at 856. For example, the verification rating module 238 (FIG. 2) calculates the likelihood that the user of the device is the authorized customer based on the evidence supplied at 850 and captured at 852 by the client. Generation of the transaction rating is performed in a similar manner to that of the verification rating described above. In some implementations, the transaction rating is based at least partially on a degree of match between the evidence supplied by the customer or the device and previously stored data; the amount of the transaction; the location of the transaction; the type of the transaction; the customer's verification rating; whether authorization of consent was received; or the like.

The client then sends a response to the server at 858. The response contains the acknowledgment and optionally the transaction rating and/or evidence. This response is received by the server, which adds a transaction response event to the previously created certificate at 860. In some implementations, the customer acknowledgement 854 is stored as a consent 720 (FIG. 7) in the certificate, and the transaction rating is stored in the certificate as transaction rating 722 (FIG. 7).

Based on the transaction rating and/or the response received from the client, the server then determines whether it requires additional approval from the bank at 862. If no further bank approval is required (862—No), then the server determines whether the transaction rating and/or the response from the client meets a threshold for non-fraudulent activity at 887. If the server determines that the transaction rating and/or the response from the client meets a threshold for non-fraudulent activity (887—Yes), then the server sends a message to the card processor to release the previously held transaction at 868, and the card processor authorizes the transaction at 870. This entire process obtaining approval from the customer preferably occurs while the customer is still at the POS so that the transaction can still occur with minimal delay. If at 834 a block or hold was placed on the card, the server can also send a message to the card processor to unblock the card at 868.

If further bank approval is requires (862—Yes), approval is requested from the bank at 864. For example, if no acknowledgment is received from the client or the transaction is otherwise determined to be fraudulent, then approval is sought from the bank to cancel the card. Once an action response is received back from the bank at 886, it is determined whether the response from the bank and/or the client meets a threshold for non-fraudulent activity at 887. For example, the bank may instruct the server to release or deny the transaction. If the server determines that the response from the client meets a threshold for non-fraudulent activity (887—Yes), then the server sends a message to the card processor to release the previously held transaction at 868, and the card processor authorizes the transaction at 870. If at 834 a block or hold was placed on the card, the server can also send a message to the card processor to unblock or release the use of the card at 868.

If it is determined that the threshold has not been met (887—No), then the server determines whether the card should be cancelled at 884. If it is determined that the card should be cancelled (884—Yes), then the a message is sent to the card processor denying the transaction and cancelling the card at 888. In some implementations, the card processor may also then send a message to the POS denying the transaction at 890.

An additional event is added to the certificate indicating the result of the transaction at 874. The certificate is also then closed at 876. In some implementations, the certificate is then digitally signed and no further changes can be made to the certificate.

In some implementations, at any time thereafter, the bank or the customer (via the client 807) can request a copy of the certificate at 892 and 894 respectively. In response to a request, the server will validate the identity of the request against that on the certificate, and if a match is made, the certificate is then sent to the bank or customer at 896 and 898 respectively. In some implementations all of the data in the certificate is visible to the bank or the customer, while in other implementations only some information within the certificate is visible. The certificate can then be used as auditable proof that the customer acknowledged that the transaction was valid and or authorized.

It should be appreciated to those of skill in the art that fewer or more steps than those described above in relation to FIGS. 8A-8C may be performed. Moreover, certain steps may be performed at different devices, e.g., actions performed by the bank may be performed by the server. Also, actions performed by one device may be separated among different devices or actions of different devices may be consolidated and performed by one device.

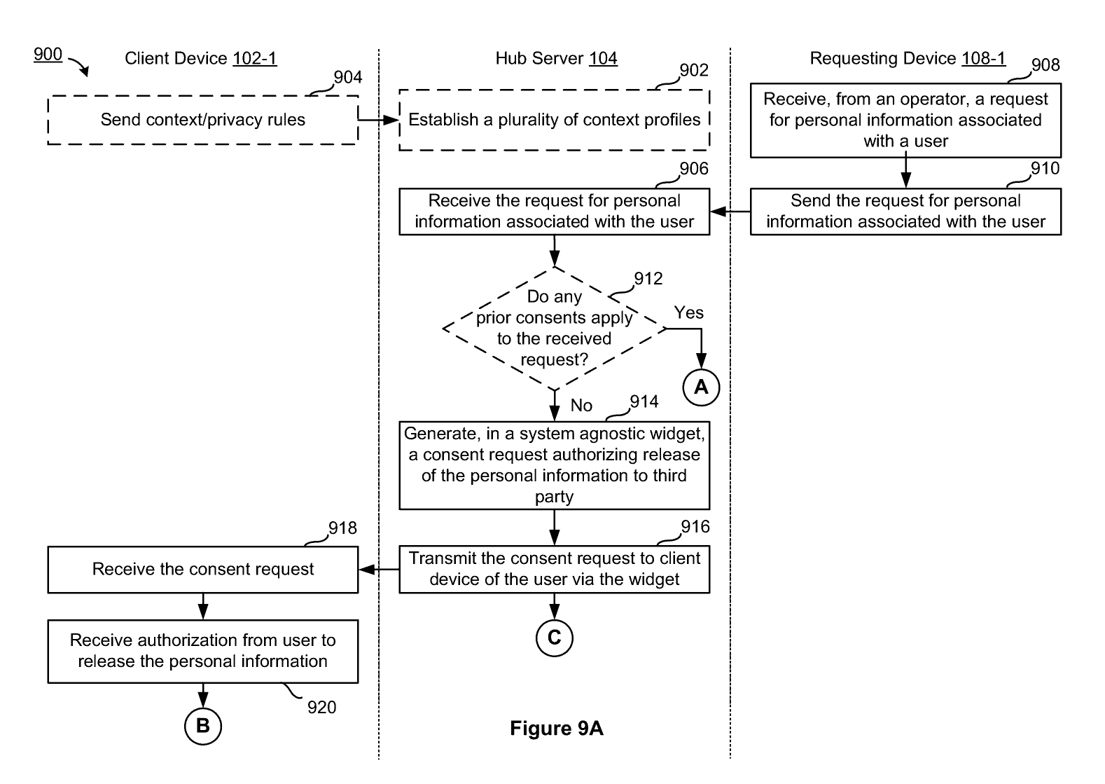

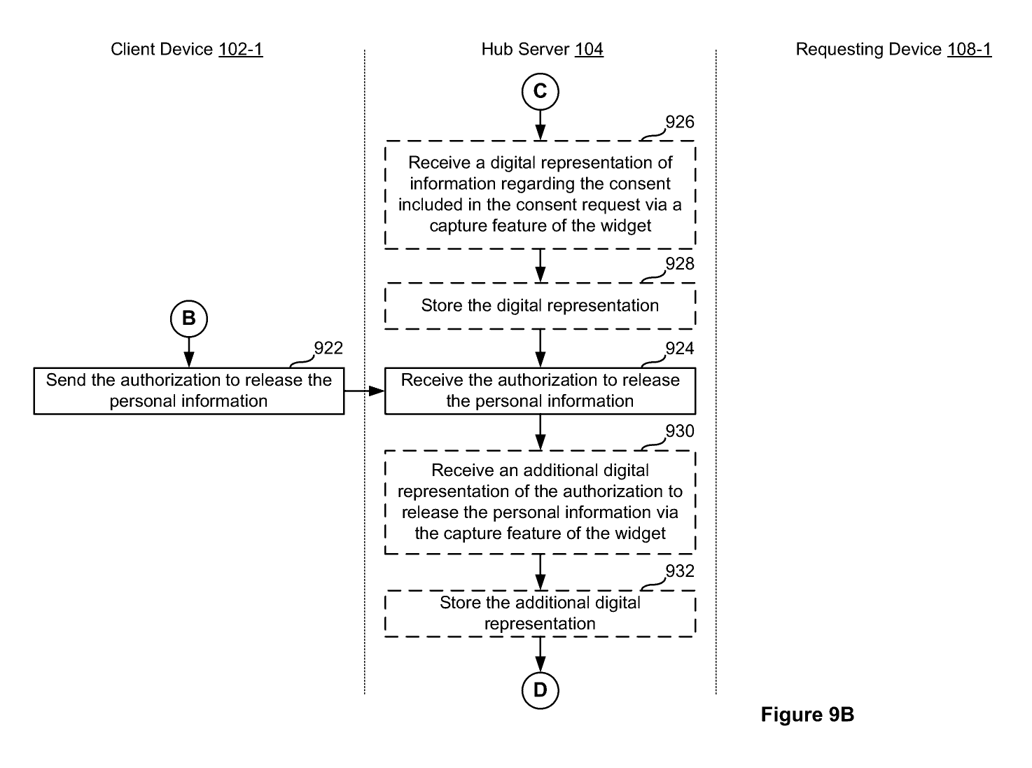

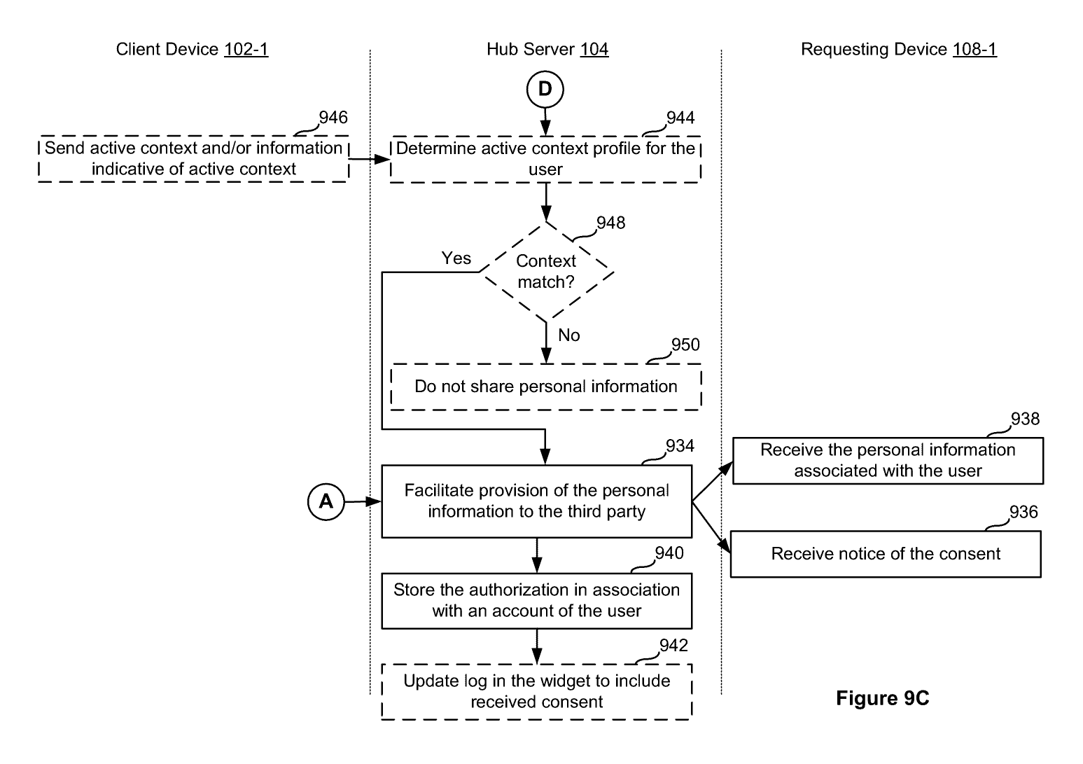

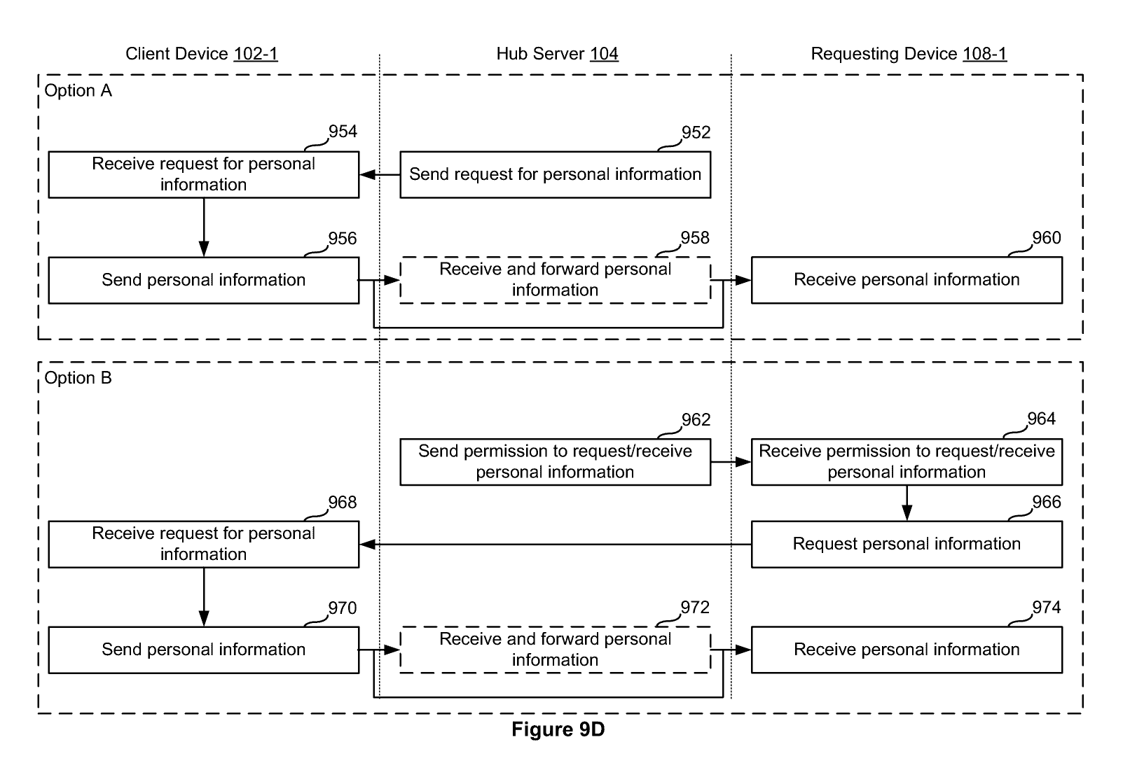

FIGS. 9A-9D are flow diagrams illustrating a method 900 for authorizing release of personal information (PII) of a user to third party, in accordance with some implementations. Each of the operations shown in FIGS. 9A-9D may correspond to instructions stored in a computer memory or computer readable storage medium. In some implementations, the steps are performed at an electronic device with one or more processors (or cores) and memory storing one or more programs for execution by the one or more processors (or cores). For example, in some implementations, the steps are performed at any one (or any combination) of the client device 102-1, the hub server 104, and the requesting device 108-1. Moreover, the individual steps of the method may be distributed among the multiple electronic devices in any appropriate manner. In some implementations, the steps of the method 900 may be performed in conjunction with one or more steps of the methods 500 and 800. For example, the steps of the method 900 may further include encryption steps described in method 500.

FIG. 10A illustrates an exemplary graphical user interface (GUI) of a consent request transmitted to the client device 102-1 via a system agnostic widget (e.g., widget 115, FIG. 1B). FIG. 10B illustrates an exemplary GUI of a consent log transmitted to the client device 102-1 via the system agnostic widget. To assist with describing the method 900, the method 900 will be described with reference to the exemplary GUIs illustrated in FIGS. 10A and 10B.

Any or all of the communications between devices described with respect to FIGS. 9A-9D are, in some implementations, secured and/or encrypted using any appropriate security and/or encryption techniques, including but not limited to Hypertext Transport Protocol Secure (HTTPS), Secure Sockets Layer (SSL), Transport Layer Security (TLS), Secure Shell (SSH), Internet Protocol Security (IPSec), public key encryption, and the like (including any appropriate yet to be developed security and/or encryption method).

In performing the method 900, in some implementations, the hub server 104 establishes (902) a plurality of context profiles for a user. In some implementations, context profiles are automatically triggered (e.g., a detection that user is in a car triggers a “travel” profile). In some implementations, context profiles relate to one or more aspects of the user's environment, current activity, or current interest(s). In some implementations, the user manually selects an active context profile. In some implementations, the client device 102-1 sends (904) context/privacy rules to the hub server 104 which the hub server 104 uses to establish the plurality of context profiles.

In performing the method 900, the hub server 104 detects an event associated with a request for personal information of the user. In some implementations, personal information of the user is information that can be used, either alone or in combination with other information, to uniquely identify a particular person. For example, personal information may include information generated and/or stored by the client device 102-1 such as internet browsing history, user profiles, location information, application usage information, device operational information/logs, and the like. In another example, personal information may include documents (or digital representations of documents) such as drivers' licenses, passports, utility bills, and the like.

In some implementations, detecting the event comprises receiving (906) a request for the personal information of the user. For example, the server 104 (or another party) possesses the personal information of the user and the requesting device 108-1 is seeking authorization (e.g., permission, consent) to obtain the personal information from the server 104 (or the other party). In some circumstances or situations, the server 104 may not possess the personal information at the time of the request. Instead, the requesting device 108-1 may be seeking authorization to start obtaining data generated by the client device 102-1 (e.g., location data). In some implementations, detecting the event associated with the request for personal information comprises receiving a request to reuse (e.g., repurpose) the personal information of the user. For example, the requesting device 108-1 may possess the personal information and may be seeking authorization to reuse the personal information (e.g., for the same purpose or for a new, unconsented to purpose) and/or is seeking to provide the personal information to an unrelated third party.

In some implementations, the requesting device 108-1 receives (908), from an operator, the request for the personal information of the user. In response to receiving the request from the operator, the requesting device 108-1 sends (910) the request for the personal information to the hub server 104. Alternatively, in some implementations, the requesting device 108-1 provides one or more conditions to the server 104, and when one of the one or more conditions is triggered, the requesting device 108-1 (or the server 104) requests the personal information. In some implementations, the one or more conditions may be triggered based on a context profile of the client device 102-1. For example, a respective condition of the one or more conditions may be triggered in accordance with a determination that a specific context profile is activated (e.g., the “travel” profile may trigger a request to obtain location data of the user).

In some implementations, a respective condition of the one or more conditions is triggered based on attributes of the client device 102-1 (and/or attributes of the user of the client device 102-1). For example, inclusion of the client device 102-1 in a target list of client devices provided to the server 104 by the requesting device 108-1 may trigger the respective condition. In some circumstances or situations, a region (e.g., country, state, etc.) may require enterprises (e.g., requesting device 108-1) to obtain authorization to use personal information collected by client devices located in the region. In these circumstances or situations, the requesting device 108-1 may identify client device(s) in the region (e.g., using Internet Protocol (IP) addresses) and include the client device(s) in the target list. The server 104 may take appropriate actions upon determining that the client device 102-1 is included in the target list of client devices provided by the requesting device 108-1 (e.g., generate and transmit a consent request to the client device 102-1, discussed below). In some implementations, the server 104 updates the target list of client devices after taking the appropriate actions (e.g., removing the client device 102-1 from the target list after receiving authorization (e.g., consent to share) from the client device 102-1).

In another example, user interaction with the client device 102-1 triggers the respective condition. For example, the respective condition may be triggered when the client device 102-1, in response to user interaction, downloads an application, logs into an account of a specific application, launches a specific application, and the like.

In another example, absence of a prior request (e.g., existing consents) for personal information triggers the respective condition. In some implementations, the server 104 determines (912) whether any prior requests (e.g., existing consents) for personal information apply to the request. In circumstances where one or more prior requests exist (e.g., prior requests stored in permission data 440, FIG. 4), the server 104 may compare the request with the one or more prior requests. In accordance with a determination that one of the one or more prior request applies to the request (912—Yes), the server 104 may take appropriate actions (e.g., facilitate provision of the personal information to the requesting device 108-1, determine if another condition is triggered, etc.). For example, Entity X may have previously requested permission to collect location information associated with the user (e.g., Consent A, FIG. 10B). As such, Entity X may forgo obtaining consent to collect subsequent location information associated with the user.

In some implementations, the server 104 does not facilitate provision of the personal information to the requesting device 108-1 even though a prior request applies to the request. Instead, the server 104 may generate and transmit, to the client device 102-1, a version of the prior request which differs in some respect from an original version of the prior request transmitted to the client device 102-1. Such a situation may arise when a threshold period of time has lapsed thereby requiring new (e.g., updated) consent be obtained. In another example, an information type of the personal information may require new (e.g., updated) consent. In another example, the requesting device 108-1 may have modified a policy or some other information associated with the prior request thereby requiring new (e.g., updated) consent be obtained.

In accordance with a determination that a prior request does not apply to the request (912—No), the server 104 generates (914) a consent request authorizing release (e.g., consent to share) of the personal information to a third party (e.g., the requesting device 108-1). In some implementations, the server 104 generates the consent request via a system agnostic widget (e.g., widget 115, FIG. 1B). As discussed above, the widget 115 may be a software component of the server 104 that has one or more GUIs support by code. The requesting device 108-1 may communicate with the widget and provide the widget with information regarding the consent (e.g., scope of the request, legal statements, etc.) to be included in at least some of the one or more GUIs of the widget 115.

Referring to FIG. 10A, in some implementations, the information regarding the consent is displayed in a text region 1004 of the widget 1002. The information regarding the consent may comprise a first unique identifier for the third party, a second unique identifier for the user, and/or a purpose associated with the request. Furthermore, the information regarding the consent may comprise text for statutory compliance, along with other information discussed above with reference to FIGS. 1A and 1B. In some implementations, an amount of information displayed in the text region 1004 varies depending on attributes of the client device 102-1 (i.e., widget 1002 may present different versions of the consent request to the client device 102-1 depending on the situation). For example, a first amount of information may be displayed in a first GUI (e.g., a first version) when the request relates to a client device included in a target list and a second amount of information may be displayed in a second GUI (e.g., a second version) when the request relates to another client device not included in the target list, the second amount being less than the first amount. In another example, the amount of information in the text region 1004 may vary from version to version based on context profiles and/or a purpose of the request (e.g., seeking new personal information versus seeking to reuse previously authorized personal information).

In performing the method 900, in some implementations, the server 104 transmits (916) the consent request to the client device 102-1. The client device 102-1 may receive (918) the consent request from the server 104 and may display the consent request. In some implementations, the server 104 transmits (e.g., sends) the consent request to the client device via the widget. For example, the server 104 may transmit code (e.g., JavaScript, HTML, XML, etc.) to the client device 102-1, which when rendered by an application or a web browser of the client device 102-1, results in the GUI of the widget 1002 being displayed (FIG. 10A). One skilled in the art will appreciate that various techniques may be utilized to render and display the GUI associated with the widget. For example, the GUI of the widget 1002 may be displayed in a web browser application (e.g., Chrome, Safari, Edge, etc.) that renders the code associated with the widget.

It should be noted that the GUI of the widget 1002 may be one version of the consent request presented on the client device 102-1 based on a first set of circumstances (as discussed above, an amount of information included in the consent request may vary depending on the circumstances or situation). As such, the server 104, in a second set of circumstances, may receive the request from the requesting device 108-1 and may transmit a different GUI of the widget 1002 (e.g., a different version of the consent request) to the client device 102-1. In this way, the requesting device 108-1 is relieved of creating consent requests on each occasion consent is needed. Instead, the server 104 generates the individual consent requests, via the widget, depending on the circumstance or situation.

After transmitting the consent request to the client device 102-1, the user may interact with the GUI displayed on the client device 102-1 (e.g., select Yes or No buttons displayed in the widget 1002, FIG. 10A). In some implementations, the client device 102-1 receives (920) authorization from the user to release (e.g., consent to share) the personal information (or a subset of the personal information). However, in some implementations, the client device 102-1 does not receive authorization from the user to release the personal information. The client device 102-1 may send (922) the response to the server 104 in accordance with the selection. For example, the client device 102-1 may send authorization to release the personal information to the third party (e.g., user selection 1006, FIG. 10A).

In some implementations, the request includes an option for the user to approve or deny permission for select items of requested information (i.e., less than or more than what is included in the request), and an option for the user assign the permissions (or denial of the permissions) to particular profiles of the plurality of context profiles. For example, referring to FIG. 10A, the user may interact with the GUI of the widget 1002 (e.g., touching and/or clicking on the additional options button 1008) to display specific items included in the consent request and the option to assign permissions. Furthermore, the response may authorize release of the subset of the requested information when certain context profiles are active. In some implementations, the user may interact with the widget (e.g., via the additional options button 1008) to activate (or deactivate) one or more context profiles. The context profiles are discussed in further detail below.

In some implementations, the server receives (924) authorization, from the client device 102-1, to release the requested personal information to the third party (or at least a subset of the personal information). In some implementations, the server receives the authorization via the widget. For example, referring to FIG. 10A, user selection 1006 in the widget 1002 results in the client device 102-1 sending an indication of the selection 1006 to the server 104.

In some implementations, the server 104 receives a denial of authorization, from the client device 102-1, to release the requested personal information to the third party (or at least a subset of the personal information). For example, referring to FIG. 10A, user selection of the “No” button provided in the GUI of the widget 1002 results in the server 104 receiving the denial.

In some implementations, the server 104 receives (926) a digital representation of the information regarding the consent included in the consent request via a capture feature of the widget. The digital representation may include code (e.g., JavaScript, HTML, etc.) and metadata associated with the consent request. For example, the digital representation may capture the first and second unique identifiers, the purpose associated with the request, the text for statutory compliance, and so on. In addition, the digital representation may capture other information included in the consent request such as how the widget presented the consent request to the user (e.g., in-line with text or overlaid). In response to receiving the digital representation, the server 104 may store (928) the digital representation in association with an account of the user. In this way, information regarding the request is stored in a centralized and standardized location which may be referenced at a later time by the user and/or the third party (i.e., an auditable trail is created using the widget).

In some implementations, the server receives (930) an additional digital representation of the authorization (or the denial) via the capture feature of the widget. For example, the additional digital representation includes metadata indicating a selection received in the widget (e.g., user selection 1006, FIG. 10A). Moreover, the additional digital representation may include other metadata such as time metadata, location metadata, and the like. For example, the time metadata includes a first timestamp of when the client device 102-1 displayed the consent request and a second timestamp of when a response was received. Thereafter, the server 104 may store (932) the additional digital representation in association with the account of the user. In this way, evidence (e.g., the digital representation and/or the additional digital representation) of the consent is stored in a centralized and standardized location.

In some implementations, the server 104 (or a third party) may use the digital representations to recreate the GUI displayed on the client device 102-1. Alternatively or in addition, in some implementations, the digital representations are screenshots and/or screen recordings of the display of the client device 102-1. For example, the capture feature of the widget may capture a screenshot of the display when the GUI is displayed on the display of the client device 102-1. In another example, the widget may record movement within the display (e.g., widget may record mouse movement leading up to user selection 1006, FIG. 10A). In some implementations, the server 104 may obtain additional consent from the user for the widget to obtain screenshots and/or screen recordings.

In performing the method 900, in response to receiving the authorization, the server 104 facilitates (934) provision of the personal information to the requesting device 108-1. As discussed above, in some circumstances or situations, the requesting device 108-1 possesses the personal information of the user and is seeking authorization to reuse the personal information (e.g., use the personal information for the same purpose, for a different purpose, provide the personal information to a different third party, etc.). In these circumstances or situations, the server 104, when facilitating provision of the personal information, notifies the requesting device 108-1 of the consent from the user (e.g., the requesting device 108-1 may receive (936) notice of the consent). In some circumstances or situations, however, the server 104 and/or the client device 102-1 possess the personal information. In these circumstances or situations, when facilitating provision of the personal information, the server 104 sends (e.g., forwards) the personal information to the requesting device 108-1 (e.g., the requesting device 108-1 may receive (938) the personal information associated with the user). In some implementations, sending the personal information to the requesting device 108-1 notifies the requesting device 108-1 of the consent from the user. However, in some implementations, the server 104 also provides a separate notification to the requesting device 108-1 regarding the consent.

In performing the method 900, the server 104 stores (940) the authorization to release the personal information in association with the account of the user. For example, the server 104 may store the authorization in permissions data 440 (FIG. 4). In this way, the authorization is stored in a centralized and standardized location.

In some implementations, in response to receiving the denial of the authorization, the server 104 forgoes facilitating provision of the personal information to the requesting device 108-1. In those circumstances or situations where the requesting device 108-1 possesses the personal information, the server 104 notifies the requesting device 108-1 of the denial (e.g., the notification may indicate that the requesting device 108-1 is to cease accessing the personal information completely, or the notification may indicate that the requesting device 108-1 now has limited access to the personal information). In those circumstances or situations where the server 104 and/or the client device 102-1 possess the personal information, the server 104 notifies the requesting device 108-1 of the denial (e.g., the notification may indicate that the requesting device 108-1 will not be receiving access to the personal information).

In some implementations, the server 104 stores the denial of authorization in association with the account of the user. For example, the server 104 may store the denial in permissions data 440 (FIG. 4). In this way, the denial is stored in a centralized and standardized location.

In some implementations, the widget includes one or more GUIs associated with a consent log. The consent log may include consents (e.g., authorizations and/or denials) provided by various users. Moreover, the consent log may include sections for specific user accounts. Accordingly, the server 104 may store respective consent logs in association with individual accounts of users. As such, the server 104 may update (942) the consent log via the widget to include the received consent from the user. In this way, an easy to use and easy to understand log of previous consents is maintained by the server 104. Moreover, the consent log is displayed in such a manner that a clear auditable trail is presented. In addition, the server 104 may update a target list, for example, by removing the client device 102-1 from the target list after receiving the authorization from the client device 102-1.

In some implementations, the server 104 receives a view request, from the client device 102-1 of the user, to view the consent log comprising one or more consents authorizing release (and/or denial of release) of personal information of the user. For example, the user may have, over a period of time, authorized release of personal information to various entities (e.g., an entity associated with the requesting device 108-1). In response to receiving the view request, the server 104 may transmit the consent log to the client device 102-1 via the widget. The client device 102-1 may display the consent log in a GUI upon receiving the widget from the server 104 (e.g., GUI of the widget 1010, FIG. 10B). The GUI may include a list of consents (and/or denials of consent) and information associated with each of the consents (e.g., entity associated with the consent, personal information associated with the consent, date of consent, context of the consent, and the like). In addition, the GUI may include one or more affordances allowing the user to revoke one or more of the consents (or denials) included in the list of consents.

In some implementations, after transmitting the widget 1010 to the client device, the server 104 receives one or more revoke requests from the user revoking at least one consent of the one or more consents authorizing release of the personal information. For example, referring to FIG. 10B, user selection 1012 revokes Consent A associated with Entity X. Alternatively or in addition, in some implementations, the server 104 receives one or more authorization requests revoking at least one denial of consent (e.g., Denial C). In some implementations, the server 104 notifies a relevant entity (e.g., requesting device 108-1) in accordance with the user selection in the widget 1010. In addition, the server 104 may update the consent log to reflect the user selection in the widget 1010. For example, after user selection 1012 revokes Consent A associated with Entity X, the server 104 may update the consent log by removing Consent A from the consent log or by displaying Consent A as Denial A.

It should be noted that the context profiles steps described below are optional.

In some implementations, the server 104, when receiving consent from the client device 102-1, receives consent when at least a first context profile, of the plurality of context profiles, is active. In particular, consent may be tied to specific profiles; i.e., the user may consent to sharing of personal information with the particular third party in some profiles but not in other profiles. In some implementations, the method further comprises receiving, from the user, denial of consent to share at least a subset of the requested personal information with the third party when at least a second context profile, of the plurality of context profiles, is active. Thus, for example, a user can permit a third party to access and/or use PII (e.g., the user's height, weight, clothing size, and shopping habits) when the user is in a first profile (e.g., a “shopping” profile), but not when the user is in another profile (e.g., a “work” profile). In some implementations, the user may define the plurality of context profiles using the widget (e.g., user may request widget 1010 from server 104 to define the plurality of context profiles, for example, using the additional options button 1014, FIG. 10B).

In some implementations, the server 104 determines (944) an active context profile for the user based on one or more signals indicative of the user's context. In some implementation, the client device 102-1 sends (946) active context and/or information indicative of active context to the server 104. Alternatively, in some implementations, the active context profile for the user is determined automatically without user input. For example, the active context profile is based on heuristics about the user's location, activity, etc., including whether the user is driving, working out, at home, at work, at a shopping establishment, and the like. The signals can be from any of multiple devices, calendars, schedules, and the like. For example, a vehicle can send a signal to an appropriate device (e.g., a client device 102 and/or the hub server 104) when the vehicle is being driven to cause a “driving” context profile to be active. In some implementations, the signals indicative of the user's context correspond to a manual selection of a particular context profile.

In some implementations, the server 104 determines (948) whether the active context profile matches the first context profile. In accordance with a determination that the active context profile does not match the first context profile (948—No), the server 104 forgoes authorizing (950) release of the personal information of the user to the third party. In accordance with a determination that the active context profile matches the first context profile (948—Yes), the server facilitates (934) provision of the personal information to the third party (discussed above).

In some implementations, when facilitating provision of the personal information to the third party (Option A), the server sends (952) a request for the personal information, the client device 102-1 receives (954) the request and sends (956) the personal information either (1) directly to the requesting device 108-1 (960) or (2) indirectly to the requesting device 108-1 via the server 104. For example, the server 104 may receive and forward (958) the personal information to the requesting device (960). Option A may arise when the requesting device 108-1 does not possess the personal information.

In some implementations, when facilitating provision of the personal information to the third party (Option B), the server 104 sends (962) the authorization (e.g., permission) to the requesting device 108-1 and the requesting device 108-1 obtains the personal information from the client device 102-1 without additional interaction (or minor interaction) from the server 104. For example, the requesting device 108-1 receives (964) the authorization, requests (966) the personal information from the client device 102-1, and subsequently receives (974) the personal information from the client device 102-1. In some implementations, the client device 102-1, after receiving the request (968), sends (970) the personal information either (1) directly to the requesting device 108-1 or (2) indirectly to the requesting device 108-1 via the server 104 (972). Option B may arise when the requesting device 108-1 does not possess the personal information.

In some implementations, the method further includes, in accordance with a determination that the active context profile matches the first context profile, permitting the third party to contact the user. The third party may be permitted to contact the user via any appropriate communication technique, including a banner advertisement, direct message (email, text, etc.), voice call/alert, and the like. In accordance with a determination that the active context profile does not match the first context profile, the method further includes not permitting the third party to contact the user.

In some implementations, the method further includes receiving a communication from the third party. The communication is addressed to or otherwise intended for a particular user. The method further includes, in accordance with a determination that the active context profile matches the first context profile, forwarding the communication (e.g., an email, text, ad banner, voice call/alert, etc.) to the user. In accordance with a determination that the active context profile does not match the first context profile, the method includes not forwarding the communication to the user.

Also described is a method for providing increased permissions to personal information of a user (e.g., via a “discovery” mode), in accordance with some implementations. In some implementations, the steps are performed at an electronic device with one or more processors (or cores) and memory storing one or more programs for execution by the one or more processors (or cores). For example, in some implementations, the steps are performed at any one (or any combination) of the client device 102-1, the hub server 104, and the requesting device 108-1. Moreover, the individual steps of the method may be distributed among the multiple electronic devices in any appropriate manner.

The method includes, in some implementations, establishing a plurality of context profiles for a user, wherein at least one context profile of the plurality of context profiles is associated with one or more of the following:
A set of one or more subject areas pertinent to the at least one context profile. Subject areas pertinent to a context profile include categories of goods or services that are relevant to a particular context. For example, subject areas pertinent to a travel profile include, for example, gas stations, food, auto repair, etc. Subject areas pertinent to a home profile include, for example, television/entertainment information, food delivery, home goods, etc. Subject areas pertinent to a shopping profile include, for example, retail stores, clothes, electronics, any product classes associated with a user profile, etc.
A first set of zero or more permissions identifying respective third parties with which personal information can be shared when the at least one context profile is active. In particular, each context profile identifies with whom PII can be shared (and/or who can use the user's PII) when that context profile is active.
A second set of zero or more permissions identifying what personal information can be shared with respective third parties when the at least one context profile is active. In particular, each context profile identifies zero or more categories, classes, or instances of personally identifiable information that can be shared with or accessed/used by respective third parties. For example, the second set of permissions may include a permission indicating that heart rate and location information can be shared with a particular fitness monitoring service when the active context is “fitness.”
A third set of zero or more permissions identifying respective third parties that are permitted to contact the user when the at least one context profile is active. In particular, only some third parties (e.g., retailers, advertisers, service providers, etc.) are permitted to contact the user when a particular profile is active. For example, a clothing retailer may be permitted to contact the user (e.g., via email, banner advertisement, etc.) when the user's “shopping” profile is active.
A fourth set of zero or more permissions identifying how respective third parties may contact the user when the at least one context profile is active (e.g., via email, banner advertisements (browser/application based), etc. when the at least one context profile is active.

The method further includes, when operating in a regular mode, performing at least one of the following actions in some implementations. (In some implementations, a regular mode corresponds to a mode where the established permissions associated with the context profile are enforced; e.g., only approved third parties can receive approved information, and only approved third parties can contact the user, and only via approved communication types.)
Sharing personal information with respective third parties in accordance with the first set of one or more permissions and the second set of one or more permissions (e.g., providing PII to certain third parties and refusing to provide PII to other third parties).
Receiving information from respective third parties in accordance with the third set of one or more permissions and the fourth set of one or more permissions (e.g., receiving emails, advertisements, text messages, banner ads, etc., from certain third parties, and refusing to receive communications from other third parties).

The method further includes, when in a discovery mode, performing at least one of the following in some implementations. (In some implementations, a discovery mode corresponds to a mode where the context of the profile still applies, but additional permissions are granted, for example, to allow other not-yet-approved third parties access a user, and/or to allow third parties to access a user via additional communications methodologies that were not previously permitted (e.g., banner ads are allowed from a particular third party when in discovery mode, but are otherwise disallowed)).
Sharing personal information with first additional third parties in accordance with an expanded version of the first set of zero or more permissions. For example, when a shopping profile is active, a user may allow a certain set of retailers to receive and/or use PII. In the discovery mode, however, additional retailers who are not otherwise permitted to receive and/or use PII will be permitted to do so. In some implementations, the first additional third parties are each associated with at least one subject area of the set of one or more subject areas pertinent to the at least one context profile. Thus, if a discovery mode for a travel context profile will only grant expanded permissions to additional third parties who are associated with subject areas such as gas stations, food, auto repair, and the like.
Sharing additional personal information with respective third parties in accordance with an expanded version of the second set of zero or more permissions. For example, when a shopping profile is active, a user's clothing size may be shared with a particular set of third parties. In the discovery mode, additional information is shared, such as the user's age, purchase history, previous purchases, location, and the like.
Receiving information from second additional third parties in accordance with an expanded version of the third set of zero or more permissions. For example, in a shopping profile, certain retailers are permitted to send information, such as advertisements, emails, and the like, to the user. In discovery mode, additional retailers would be permitted to do so. In some implementations, the second additional third parties are each associated with at least one subject area of the set of one or more subject areas pertinent to the at least one context profile. For example, in a shopping profile, the additional third parties may be restricted to other retailers. Thus, while additional, otherwise unauthorized third parties may send information to the user, the information would still be pertinent to the user's otherwise active context profile.
Receiving information from respective third parties in accordance with an expanded version of the fourth set of zero or more permissions. As noted above, the fourth set of permissions relates to how a third party can contact a user. Accordingly, an expanded version of the fourth set of permissions allows third parties to use additional modes of communication that are not otherwise permitted. For example, a retailer that is only permitted to contact the user by email when the normal mode is active would be able to use additional modes of communication (e.g., text messages, pop-up ads, etc.) when the discovery mode is active.

As noted above, discovery mode need not grant full permissions to all possible third parties. Rather, the additional permissions granted in discovery mode may be established by each individual user, and may be only a small increase in permissions.

In some implementations, the fourth set of one or more permissions identifying how third parties may contact the user includes a first subset of permissions identifying times when third parties are permitted to contact the user; and a second subset of permissions identifying communication types that third parties are permitted to use to contact the user.

In some implementations, the fourth set of one or more permissions identifying how third parties may contact the user includes a third subset of permissions identifying times when third parties are not permitted to contact the user; and a fourth subset of permissions identifying communication types that third parties are not permitted to use to contact the user.

The methods illustrated in FIGS. 5A-5D, 8A-8C, and 9A-9D may be governed by instructions that are stored in a computer readable storage medium and that are executed by at least one processor of at least one electronic device (e.g., one or more client devices 102-n, one or more requesting devices 108-n, or a server 104). Each of the operations shown in these figures may correspond to instructions stored in a non-transitory computer memory or computer readable storage medium. In various implementations, the non-transitory computer readable storage medium includes a magnetic or optical disk storage device, solid state storage devices, such as Flash memory, or other non-volatile memory device or devices. The computer readable instructions stored on the non-transitory computer readable storage medium may be in source code, assembly language code, object code, or other instruction format that is interpreted and/or executable by one or more processors (or cores).

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

It will also be understood that, although the terms “first,” “second,” etc. may be used herein to describe various elements, these elements should not be limited by these terms. These terms are only used to distinguish one element from another. For example, a first context could be termed a second context, and, similarly, a second context could be termed a first context, which changing the meaning of the description, so long as all occurrences of the “first context” are renamed consistently and all occurrences of the second context are renamed consistently. The first context and the second context are both contexts, but they are not the same context unless specified otherwise.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative implementations. For purposes of explanation, numerous specific details were set forth in order to provide an understanding of various implementations of the inventive subject matter. It will be evident, however, to those skilled in the art that implementations of the inventive subject matter may be practiced without these specific details. In general, well-known instruction instances, protocols, structures and techniques have not been shown in detail.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

What is claimed is:

1. A method, comprising:
at a server system with one or more server processors and server memory storing one or more server programs for execution by the one or more server processors:
receiving, from a third party, a request for personal information associated with a user;
generating, in a system agnostic widget, a consent request for requesting authorization to release the personal information associated with the user to the third party;
transmitting the consent request to a client device of the user via the widget; and
in response to receiving authorization to release the personal information from the client device via the widget:
facilitating provision of the personal information to the third party, and
storing the authorization in association with an account of the user.

2. The method of claim 1, wherein the consent request comprises information regarding the consent.

3. The method of claim 2, wherein the information regarding the consent comprises a first unique identifier for the third party, a second unique identifier for the user, and a context associated with the request.

4. The method of claim 3, wherein the information regarding the consent further comprises text for statutory compliance.

5. The method of claim 2, further comprising, at the server system:
receiving a digital representation of the information regarding the consent included in the consent request via a capture feature of the widget; and
storing the digital representation in association with the account of the user.

6. The method of claim 5, further comprising, at the server system:
receiving an additional digital representation of the authorization received in the system agnostic widget via the capture feature of the widget; and
storing the additional digital representation in association with the account of the user.

7. The method of claim 1, further comprising, at the server system, determining whether any prior consents received from the user apply to the request,
wherein generating the consent request is performed upon determining that none of the prior consents apply to the request.

8. The method of claim 1, wherein the personal information associated with the user is stored in a database controlled by the third party or another third party.

9. The method of claim 1, further comprising, at the server system, before receiving the request from the third party:
receiving, from the client device, the personal information of the user; and
storing the personal information in association with the account of the user.

10. The method of claim 9, wherein facilitating provision of the personal information to the third party comprising forwarding the stored personal information to the third party.

11. The method of claim 1, further comprising, at the server system, subsequent to receiving the authorization to release in the system agnostic widget from the user, updating a log in the widget to include the consent authorizing release of the personal information to the third party.

12. The method of claim 11, further comprising, at the server system:
receiving a view request, from the client device of the user, to view the log comprising one or more consents authorizing release of the personal information;
transmitting the log to the client device via the widget; and
after transmitting the log to the client device via the widget, receiving one or more revoke requests from the user revoking at least one consent of the one or more consents authorizing release of the personal information.

13. A method, comprising:
at a server system with one or more server processors and server memory storing one or more server programs for execution by the one or more server processors:
receiving, from a third party, a request for personal information associated with a user;
generating a consent request for requesting authorization to release the personal information associated with the user to the third party;
transmitting the consent request to a client device of the user; and
receiving, from the client device, consent authorization release of the requested personal information to the third party;
in response to receiving authorization to release the personal information from the client device:
facilitating provision of the personal information to the third party, and
storing the authorization in association with an account of the user.

14. The method of claim 13, wherein:
generating the consent request comprises generating the consent request in a system agnostic widget;
transmitting the consent request to the client device comprises transmitting the consent request via the widget; and
receiving the consent authorization release of the requested personal information comprises receiving the consent via the widget.

15. The method of claim 14, wherein:
the consent request comprises information regarding the consent; and
the information regarding the consent comprises a first unique identifier for the third party, a second unique identifier for the user, and a context associated with the request.

16. The method of claim 15, further comprising, at the server system:
receiving a digital representation of the information regarding the consent included in the consent request via a capture feature of the widget; and
storing the digital representation in association with the account of the user.

17. The method of claim 13, further comprising, at the server system, determining whether any prior consents received from the user apply to the request,
wherein generating the consent request is performed upon determining that none of the prior consents apply to the request.

18. A server system, comprising:
one or more processors; and
memory storing one or more programs for execution by the one or more processors, the one or more programs including instructions for:
receiving, from a third party, a request for personal information associated with a user;
generating, in a system agnostic widget, a consent request for requesting authorization to release the personal information associated with the user to the third party;
transmitting the consent request to a client device of the user via the widget; and
in response to receiving authorization to release the personal information from the client device via the widget:
facilitating provision of the personal information to the third party, and
storing the authorization in association with an account of the user.

19. The server system of claim 18, wherein the consent request comprises information regarding the consent.

20. The server system of claim 19, further comprising instructions for:
receiving a digital representation of the information regarding the consent included in the consent request via a capture feature of the widget; and
storing the digital representation in association with the account of the user.
